(19) United States
(12) Patent Application Publication
(10) Pub. No.: US 2022/0363557 A1
(43) Pub. Date: Nov. 17, 2022

(54) THORIUM PEROXIDE-BASED GENERATORS FOR AC-225 GENERATION

(71) Applicant: TerraPower, LLc, Bellevue, WA (US)

(72) Inventors: Ken Czerwinski, Seattle, WA (US); Hilary Fitzgerald, North Bend, WA (US)

(21) Appl. No.: 17/742,116

(22) Filed: May 11, 2022

Related U.S. Application Data
(60) Provisional application No. 63/187,728, filed on May 12, 2021.

(51) Int. Cl. C01F 17/00

(52) U.S. Cl. CPC C01F 17/00

(57) ABSTRACT

The actinium generator described herein is based on peroxide precipitation of thorium from its daughter products radium and actinium. In this system, the “actinium generator” is a quantity of solid thorium peroxide stored under a cover solution. The thorium peroxide is stored as a suspension to allow for the buildup of the decay products radium and actinium in the suspension. The suspension is then treated with a peroxide solution and the solid and liquid phases are separated. The thorium remains in the solid peroxide form while the soluble actinium and radium are removed with the liquid phase in a rinsing step. After rinsing, an amount of the rinsing solution is retained with the thorium peroxide solid as a fresh cover solution to form another suspension for storage. This new suspension is then stored to allow actinium and radium to again build up in the suspension for a subsequent separation cycle.

### CROSS REFERENCE TO RELATED APPLICATIONS

This application claims the benefit of U.S. Provisional Application No. 63/187,728, filed May 12, 2021, which application is hereby incorporated by reference.

### INTRODUCTION

Alpha-emitting radionuclides offer promise as radiotherapeutic agents in the treatment of a wide and diverse range of malignancies. The high energies of alpha particles make them capable of destroying malignant tumors, while their short penetration depth limits the extent of damage to the surrounding healthy tissues. Of particular interest to medical researchers is actinium (Ac) and, particularly, the radioisotope of Ac-225 (²²⁵Ac) for use in Targeted Alpha Therapy (TAT). The appeal of ²²⁵Ac is its nearly ideal 10-day half-life and the range of the alpha particle emitted, which is approximately the same size as a human cell. Ligands would be used to attach the ²²⁵Ac to the monoclonal antibodies, which are preprogrammed for targeted transmission and delivery of these alpha emitters to the diseased cells.

Currently, ²²⁵Ac is produced by the irradiation of thorium (Th) metal with a proton beam. Irradiation of thorium metal including ²³²Th can yield over 700 different isotopes of potential interest, including ²²⁵Ra, which decays into ²²⁵Ac. The desired radionuclides can be recovered subsequent to proton irradiation by dissolving the irradiated thorium in an acidic solution, and various chromatography techniques can be used to effect a separation of the desired actinium and radium products from the thorium starting material and other spallation products.

In addition to the production of actinium and radium, the irradiation of ²³²Th metal creates a substantial amount of undesirable radioisotopes relative to the desired radionuclide products. For example, radioactive isotopes of lower lanthanide elements (e.g. lanthanum and cerium) are not desirable in preparations of radioisotopes intended for use in medical applications. Thus, such undesirable radioactive isotopes must be removed.

### Thorium Peroxide-Based Generator for Ac-225 Generation

The studies described herein provide evidence that the formation of thorium peroxide is a suitable method for the chemical separation of ²³²Th from ²²⁸Ra and ²²⁸Ac. Because the isotopes ²³²Th, ²²⁸Ra, and ²²⁸Ac are surrogates for ²²⁹Th, ²²⁵Ra, and ²²⁵Ac, respectively, it is believed that this separation technique will be equally applicable to the chemical separation of ²²⁹Th from ²²⁵Ra and ²²⁵Ac and, thus, can be used to form the basis for an ²²⁵Ac generator. Results indicate that thorium may be separated from radium and actinium by the precipitation of thorium out of solution at pH=1.5-2.0. This is achieved by the addition of 30% hydrogen peroxide to an acidic solution containing Th, Ra and Ac, and the subsequent addition of a basic solution until the pH=1.5-2.0. Unless otherwise stated, all percentages discussed herein are % by weight.

The method of liquid—solid separation varies depending on the amount of Th present. Small scale separations, containing approximately 50 mg of Th, were easily be achieved by centrifugation and removal of the solution phase via pipette. Large scale separations, utilizing over one gram of Th, were achieved with simple filtration glassware. At large scale, rinsing with a pH=1.5-2.0 solution of the thorium peroxide solid is required to increase radium and actinium recovery. The addition of 30% hydrogen peroxide to each rinse cycle was found to further facilitate the retention of thorium in the solid phase.

Initial experimentation, at 50 mg scale, demonstrated that close to 100% of the radium and actinium may be recovered from the partitioned thorium. Results of the study at the 2.5-gram scale have provided evidence that 99.998% thorium recovery is possible with the current, “off the shelf”, filtration glassware. This number may improve with specialized separation equipment and continued research, for example 99.999% recovery has been demonstrated with an additional filtration step.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 is a schematic view of the decay chain of ²³³U to ²²⁹Th and subsequent daughters.

FIG. 2 illustrates an embodiment of the peroxide separation method suitable for use at scale.

FIG. 3 illustrates an example of a simple actinium generator in the form of a column containing the solid phase thorium peroxide in a suspension with liquid phase storage solution.

FIG. 4 shows the synthesis and filtering apparatus used for the one-gram test #1.

FIG. 5 shows the synthesis and filtering apparatus used for the one-gram test #2.

FIG. 6 shows the synthesis and filtering apparatus used for the one-gram test #3.

FIG. 7 shows the synthesis and filtering apparatus used for the one-gram test #5.

FIG. 8 shows the filtration apparatus used for the 2.5-gram test #1.

### DETAILED DESCRIPTION

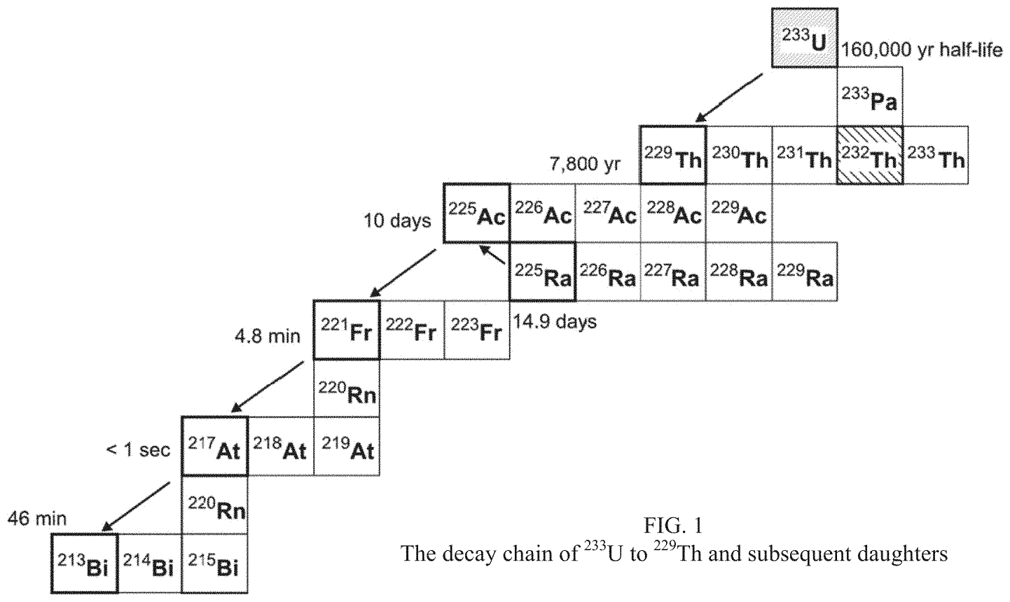

This document describes systems and methods of generating ²²⁵Ac from a different isotope of Th: ²²⁹Th. In this system, the ²²⁵Ac is generated from ²²⁹Th, which originates from ²³³U. The natural decay of ²²⁹Th produces ²²⁵Ra, which beta decays to ²²¹Ac (FIG. 1). As shown, ²³³U has a half-life of 160,000 years, and it decays to ²²⁹Th. The ²²⁹Th has a half-life of 7917 years, and decays to ²²⁵Ra, which has a 14.9-day half-life. The ²²⁵Ra decays to ²²⁵Ac, which has a 10-day half-life. Because of these relatively short half-lives, ²²⁵Ra and ²²⁵Ac must be “milked” from the ²²⁹Th on a regular basis.

The actinium generator described herein is based on peroxide precipitation of thorium from its daughter products, in particular radium and actinium. In this system, the “actinium generator” is a quantity of solid thorium peroxide stored under a cover solution, such as a sodium nitrate or a nitric acid solution. For convenience, the solid thorium peroxide and cover solution together may be referred to herein variously as the “thorium peroxide-sodium nitrate suspension” (in cases where sodium nitrate is the cover solution), the “thorium peroxide suspension” or, simply, the “suspension”. In chemistry, a suspension is a heterogeneous combination of a solid particulate in a liquid phase in which at least some of the particles will settle out of the mixture upon standing. Although the term suspension properly refers to a solid-liquid combination when the solid is dispersed throughout the liquid, it is used herein to refer to the thorium peroxide-cover solution combination regardless of whether the two phases are dispersed or not.

The solid thorium peroxide suspension is stored for some period of time to allow for the buildup of the decay products radium and actinium in the suspension. For example, in an embodiment the thorium peroxide suspension in maintained in a vessel for a period of time to generate radium and actinium. The suspension is then treated with a peroxide solution and the solid and liquid phases are separated. In this system, the thorium remains in the solid peroxide form while the soluble daughters (decay products including Ac and Ra) are removed with the liquid phase in a rinsing step. After rinsing, an amount of the rinsing solution is retained with the thorium peroxide solid as a fresh sodium cover solution to form another thorium peroxide suspension for storage. This new suspension is then stored to allow actinium and radium to again build up in the suspension in preparation for a subsequent separation cycle.

In the system described, if new thorium is not periodically added, the separations may be periodically performed on the thorium peroxide until such time as the remaining amount of thorium is so small that it is no longer commercially viable to perform separations on the remaining thorium. For a ²²⁵Ac generator, since the ²²⁵Ra has a 14.9-day half-life its daughter the ²²⁵Ac has a 10-day half-life, a milking period of less than 25 days is an option, while more frequent milking periods of 20 days or less, 15 days or less, 10 days or less, 5 days or less, 4 days or less, 3 days or less, 2 days or less, every day or even more frequently are contemplated depending on the need and the size of the generator (i.e., the mass of ²²⁹Th used).

In an embodiment, the thorium peroxide is maintained in the same vessel (e.g., a filter funnel) throughout the multiple separations and storage cycles. In this embodiment, the vessel containing the thorium peroxide may be referred to as the ‘actinium generator’ or ‘radium generator’ as the vessel is where those two elements are created and from which they are periodically obtained. In an alternative embodiment, the thorium peroxide could be maintained as a suspension in a different container than that used for the solid-liquid separation or could even be maintained as a solid.

In an embodiment, throughout the handling of thorium peroxide an excess of peroxide is maintained into order to prevent and minimize the chance that any compound of thorium other than thorium peroxide will be created and potentially lost with the liquid phase of the separations. Likewise, regardless of the ultimate system and equipment used, the prevention of any solid loss during separations will also maximize retention of the thorium source.

The actinium generator systems and methods described herein will generate either ²²⁵Ra and ²²⁵Ac or ²²⁸Ra and ²²⁸Ac depending on which isotope of thorium is used as the source material, i.e., ²²⁹Th or ²³²Th. Except where explicitly stated (such as in the Examples provided below) when the elements actinium, radium or thorium are used herein without specifying an isotope, the discussion is generally applicable to any isotope of the elements. For example, when the phrase “actinium generator” is used without specifying the particular isotope, the reader will understand that the discussion is equally applicable to either a ²²⁵Ac generator or a ²²⁸Ac generator.

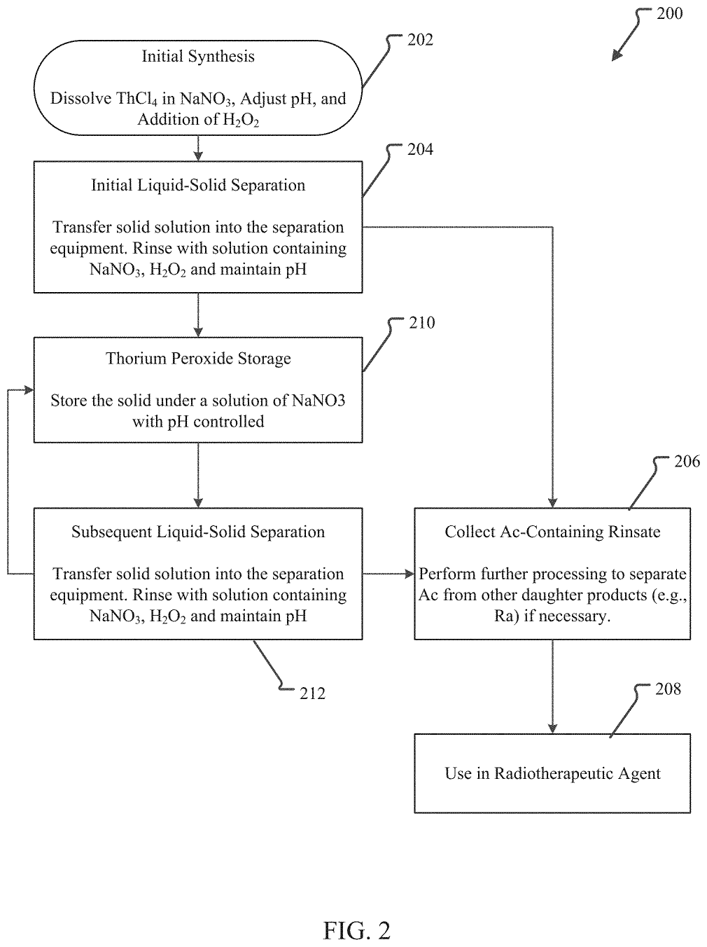

FIG. 2 illustrates an embodiment of the peroxide separation method suitable for use at scale. The method 200 begins with an initial synthesis of thorium peroxide solid from a starting material in a synthesis operation 202. In the embodiment shown, the synthesis operation 202 converts an initial feedstock of ThCl₄.ₓH₂O or Th(NO₃)₄.ₓH₂O to thorium peroxide. The ThCl₄ or Th(NO₃)₄.ₓH₂O is dissolved in a suitable acid solution at a pH of 3 or less as shown to obtain a dissolved thorium solution. The pH of the solution may be controlled by using KOH or HNO₃ as needed. In an embodiment, a target pH of from 0.5-3.0 is maintained in the solution. In an alternative embodiment, a narrower range of from 1.0-2.5 is used. In yet another embodiment an even more narrow range of pH of 1.5-2.0 is maintained.

A hydrogen peroxide solution (e.g., from 5% to 50% H₂O₂ by weight, from 10% to 45%, or even from 20% to 40% may be used) is then added to the dissolved thorium chloride or thorium nitrate solution, which causes the thorium to form a precipitate within the acid solution and thereby create a thorium peroxide suspension.

The solid thorium peroxide and the liquid phase of the suspension are then separated in an initial solid-liquid separation operation 204. The separation can be by centrifugation, vacuum filtration, gravity settling, or any other liquid-solid separation technique or combination of techniques. It should be noted that the starting material will necessarily contain some amount of decay products Ra and Ac. The decay products will remain in the liquid phase and, thus, are removed from the solid phase by the separation. Thus, the result of the solid-liquid separation operation 204 is a liquid phase with radium and actinium and a solid phase with thorium peroxide.

After the separation operation 204, the liquid phase is collected in a collection operation 206. The collection operation 206 may include further processing as needed, for example to separate the ²²⁵Ra and ²²⁵Ac, for further use in radiotherapeutic agents (illustrated by operation 208).

The solid phase of thorium peroxide is then stored until the next separation cycle in a storage operation 210. In the embodiment shown, the thorium peroxide is stored on the filter in the generator vessel with fresh cover solution filing some or all of the internal chamber of the generator.

After a desired period of time to allow the stored thorium to decay, i.e., the milking period as discussed above, the solid thorium peroxide is then subjected to a subsequent solid-liquid separation operation 212 similar to the initial separation operation 204. If stored as a suspension, the phases of suspension are separated and may be mixed prior to separation or not. If stored as a solid, a new suspension is created and then subjected to a solid-liquid separation.

Subsequent solid-liquid separation operations 212 may include adding additional peroxide solution (e.g., from 5% to 50% H₂O₂ by weight, from 10% to 45%, from 20% to 40%, or even from 25% to 35% may be used). In addition, mixing or otherwise agitating the thorium peroxide suspension may also be performed. This enhances both the retention of thorium in the solid phase and the dissolution of the radium and actinium into the liquid phase. In an alternative embodiment, the separation could simply involve removing the storage solution under which the thorium peroxide was stored (with or without any agitation prior to removal) and adding new solution to replace the storage solution.

In an embodiment, hydrogen peroxide is maintained in excess in the suspension as part of the separation process. In another embodiment, hydrogen peroxide is maintained in excess whenever the thorium is in a suspension.

One or more rinsing cycles may be included as part of each separation operation 212. Rinsing may include washing with some number of volumes of a wash solution, such as solutions of NaNO₃, HNO₃, and/or H₂O₂. Whenever solutions of NaNO₃ are used herein, unless otherwise specified, aqueous solutions of from 0.01 to 10.0 M NaNO₃ may be used. Whenever solutions of HNO₃ are used herein, unless otherwise specified, aqueous solutions of from 0.01 to 10.0 M HNO₃ may be used. Whenever peroxide solutions are used herein, unless otherwise specified, aqueous solutions from 5% to 50% H₂O₂ by weight, from 10% to 45%, or even from 20% to 40% may be used.

In an embodiment, the solid phase may be stored in a shielded vessel under solution and then removed for each subsequent solid-liquid separation operation 212. The shield is provided to intercept radiation from the decaying ²²⁹Th and its radioactive daughter products. In an alternative embodiment, the solid thorium peroxide may be maintained in a reaction vessel that acts as both the storage vessel and the separation vessel. In this embodiment, subsequent separations 212 are performed by introducing the additional solution into the vessel and collecting the eluant including any rinsing solution if rinsing cycles are performed.

The solid phase may be stored alone (i.e., dry, or essentially dry) or under a storage solution as described above. However, one notable aspect of the method 200 is that drying is not required, thus saving the cost of the drying operation. In an embodiment of the method 200, the method 200 could be as simple as periodically decanting the cover solution from stored thorium suspension and replacing the removed cover solution with a fresh cover solution. In this simple embodiment, the handling of the thorium is minimized, for example, generating actinium without drying the thorium as part of each separation and without having to physically move the thorium between vessels or columns as part of each separation.

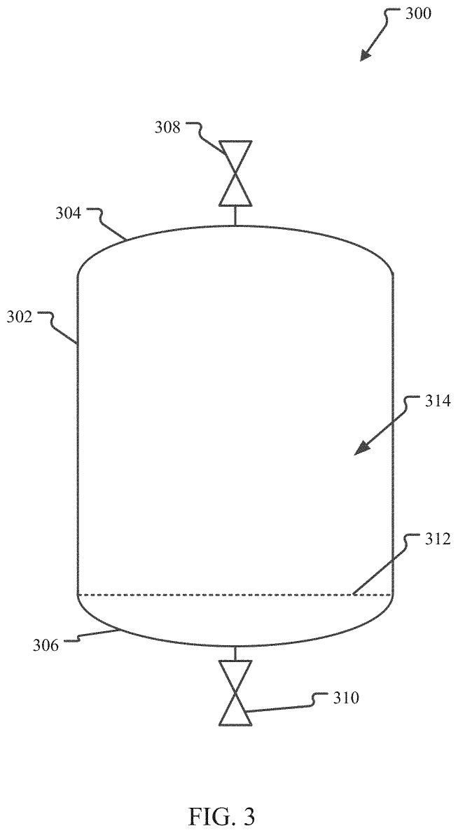

FIG. 3 illustrates an example of a simple actinium generator in the form of a column containing the solid phase thorium peroxide in a suspension with liquid phase storage solution. Although referred to as a ‘column’ herein, the generator 300 may take any shape including capsule-shaped (spherocylindrical) as illustrated, cylindrical, spherical, conical, pyramidal, frustoconical, or frustopyramidal, to name but a few.

In the embodiment shown, the generator 300 includes a cylindrical column body 302 defining an internal cavity, a hemispherical top or lid portion 304 that, when engaged, seals the cavity, and a hemispherical bottom 306. The top 304, body 302, and bottom 306 define an interior chamber 314 that contains the source material, that is, the thorium peroxide. One or both of the top 304 and the bottom 306 may be removably attached to the body 302 to allow the source material to be inserted into or removed from the generator 300. This may be achieved by any known system, such as corresponding threaded portions, for example on the lid portion and in the cylindrical body (not shown). Alternatively, the generator 300 may be of a unitary construction and the source material charged through a sealable access port (not shown) or during the construction of the generator.

In the embodiment shown, two fluid flow valves 308,310 are provided, first valve 308 (which may be an output value in some examples) in the top 304 and a second valve 310 (which may be an input valve in some examples) in the bottom 306. In yet another embodiment, the generator may not be completely sealed when the lid is engaged, for example, to allow gas to escape. Although valves 308, 310 are shown at the top and bottom of the generator 300 respectively, one of skill in the art will recognize that the valves 308, 310 can be located in any appropriate location and/or orientation and do not necessarily have to be placed on opposing sides of the generator. Similarly, any type, shape or number of valves may be used instead of the simple top and bottom configuration shown. For example, only one valve 308 may be used or multiple valves in addition to the two valves shown may be used for any of input, output, redundancy, and/or safety measures of the extraction material and/or generator. Similarly, any type, shape or number of valves, u-tubes, or openings may be used for access ports instead of the simple top and bottom configuration shown. For example, one valve 2408 or additional valves (not shown) may be used as access ports for any of input, output, redundancy, and/or safety measures of the extraction material and/or generator. In a simple configuration, the generator 2400 may have only one access port such as a bottle or beaker.

A generator 300 may be of any shape, both externally and internally in the source material chamber. Any number, type, and configuration of access ports, valves, shackles, connectors, contact points, or other ancillary components may be used as desired. For example, in the embodiment shown a diffuser 312 is provided so that the generator may be easily used as a fluidized bed or packed bed contacting reactor. In the embodiment, the diffuser is in the form of a perforated plate with perforations sized such that the source material (such as the particulate matter) is prevented or reduced from passing through it. Solvent introduced from the bottom valve 310, however, passes easily through the diffuser 312 allowing contact with the source material. Alternatively, the diffuser 312 could be a glass frit filter. This are but two examples of ancillary components that could be provided on the generator. For example, many different fluidized bed reactor designs could be incorporated into a generator having additional ancillary components such as additional diffusers, manifolds, baffles for distributing solvent flow evenly, non-cylindrical internal shape of the source material chamber/cavity 314, baffles for directing flow, etc.

Generators may be made with an opening to facilitate the insertion and removal of the physical form of source material to be used. For example, when one or more large masses of source material are used as discussed above, a generator may be provided with a relatively large opening that allow for the insertion and removal of the masses. This would allow generators to be reused after the source material is spent. Alternatively, a generator may be constructed around the source material with the intention that the source material be disposed of with the generator and no provision is made for removing the source material from the generator once the target is sufficiently spent which may reduce waste and/or waste processing.

Generators that store thorium may be further shielded from neutron transfer. Any type of shielding as is known in the art may be provided.

### Examples

In this Examples section, all mentions of thorium, radium and actinium refer to ²³²Th, ²²⁸Ra and ²²⁸Ac, unless otherwise stated.

Starting Material

The primary starting material for these studies was conducted using ThCl₄-J-H₂O. Some preliminary testing was conducted utilizing Th(NO₃)₄.ₓH₂O and results were comparable. HNO₃ and other nitrates were used to adjust pH or increase the ionic strength due to downstream (Ra/Ac separation/purification steps) requiring nitrate forms. Potassium hydroxide was consistently used for pH adjustment. 30% hydrogen peroxide was used for all experiments.

pH Range Study

Testing utilizing thorium hydroxide (not covered within this report) concluded that Th begins to hydrolyze above pH=3.0; therefore, all tests were conducted below pH=3.0. Meanwhile, initial testing concluded that thorium peroxide begins to form above pH=0. Therefore, the range of pH=0.5-3.0 was considered. Each pH range (0.5, 1.0, 1.5, 2.0, 2.5, and 3.0) was repeated in triplicate. ICP-OES was utilized to measure the [Th] in the solution phase. Gamma spectroscopy was used to determine the [Ac] and [Ra] in the solution phase as well as recovery.

Approximately 60 mg of ThCl₄.ₓH₂O (approx. 28 g of Th) was weighed into a 15 mL centrifuge tube. Then 8.5 mL of DI H₂O was added to the centrifuge tube, stirring to dissolve the ThCl₄.ₓH₂O. To the solution, 1.5 mL of 30% H₂O₂ was added, and the solution phase adjusted to the desired pH, using a KOH or HNO₃ solution.

After the allotted one-hour reaction time, the sample was centrifuged and solution phase removed via pipette for subsequent gamma, alpha and ICP-OES analysis. The samples removed for ICP-OES analysis were filtered through a 0.45 μm syringe filter.

Kinetics

Kinetics studies were conducted with using DI H₂O and 0.1 M NaNO₃ as the dissolving solution. Samples were taken at t=0 min, 15 min, 30 min, 45 min, 1 hour (hr), 2 hrs, and 3 hrs. These experiments were conducted in triplicate. One additional kinetics study was conducted at the one-gram scale.

Small Scale Experiments

Approximately 60 mg of ThCl₄.ₓH₂O (approx. 28 g of Th) was weighed into a 15 mL centrifuge tube. To the centrifuge tube 8.5 mL of DI H₂O or 0.1M NaNO₃ was added, stirring to dissolve the ThCl₄.ₓH₂O. To the solution, 1.5 mL of 30% H₂O₂ was added, and the solution phase adjusted to pH=1.6±0.1 using a KOH solution. Time was started at the time of achieving the desired pH.

After the allotted time, the sample was centrifuged, and 1 mL of the solution phase removed via pipette for subsequent ICP-OES analysis. The removed samples were filtered through a 0.45 μm syringe filter. After each 1 mL sample was removed, 1 mL of pH=1.5 HNO₃ solution was added to the centrifuge tube. All samples were submitted for ICP-OES analysis.

One Gram Scale Experiment

In a 100 mL round bottom flask, 2.3174 grams of ThCl₄.ₓH₂O (1.0626 g Th) was dissolved into 40 mL of 0.1 M NaNO₃. To the solution, 10 mL of 30% H₂O₂ was slowly added, while stirring. The pH was then adjusted with 0.5 M KOH solution until the pH=2.01. Time was started at the time of achieving desired pH.

Samples were removed via pipette at t=0, 30 min, 1 hr, 2 hrs, and 3 hrs. After the allotted time, 1 mL of the solution phase was removed via pipette and filtered through a 0.45 μm syringe filter. After each 1 mL sample was removed, 1 mL of pH=2.0 HNO₃ solution was added to the round bottom flask. All samples were submitted for ICP—OES/MS analysis.

Minimum Amount of 30% H₂O₂

Tests were conducted by adding 2 mL of 0.1 M NaNO₃ to approximately 60 mg of ThCl₄.ₓH₂O (approx. 28 g of Th), stirring to dissolve. To this solution, a range of 30% H₂O₂ volumes was added to each test. The volume of 30% H₂O₂ added ranged from 0.3 mL to 1.5 mL, each test varying by 0.1 mL. The pH was adjusted with a KOH solution to pH=1.6±0.1 and allowed one hour of reaction time.

After the allotted one-hour reaction time, the sample was centrifuged, and 1 mL of the solution phase was removed via pipette. The removed samples were filtered through a 0.45 μm syringe filter and submitted for ICP—OES/MS analysis.

Increased Ion Concentration

A series of one-gram experiments were conducted, varying the ion concentration of the solution that the thorium was initially dissolved into and with which the peroxide was subsequently rinsed during Ra and Ac retrieval (described in Sections [0082]).

Scaling up to 2.5-Grams Th, Liquid—Solid Separation and Increased Ion Concentration

One-Gram Test #1

Synthesis

In a 50 mL Kjeldahl flask, 2.2157 g of ThCl₄.ₓH₂O (1.0159 g of Th) was dissolved into 40 ml, of 0.1 M NaNO₃. To the solution, 10 mL of 30% H₂O₂ was added while stirring. The pH was then adjusted with a KOH solution to pH=1.64. One hour was allowed for reaction time prior to beginning the rinsing and filtering steps.

Sample Collection

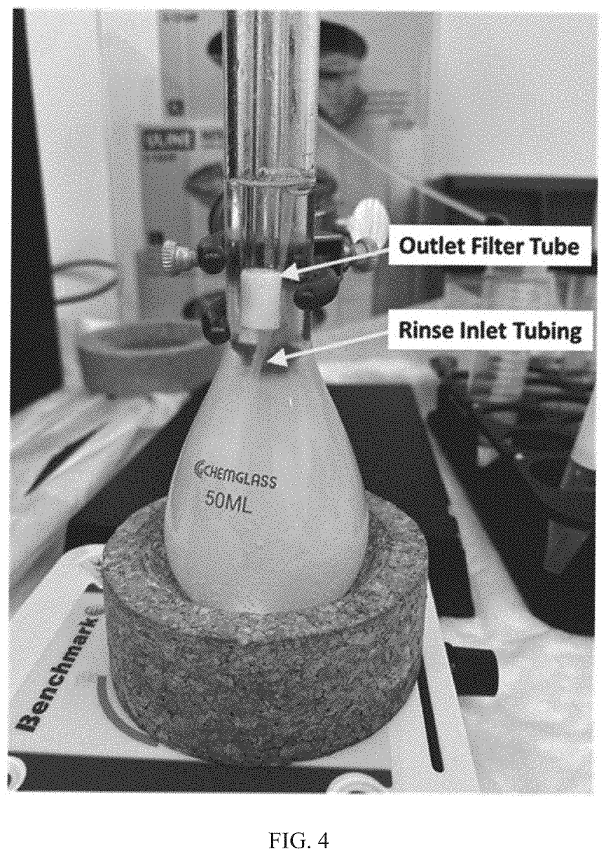

Rinsing and filtering steps were performed using a dual syringe pump at 5 mL/min. The rinse solution, a pH=2.0 HNO₃ solution, was delivered via 1/16″ tubing that was inserted and positioned at the bottom of the flask (FIG. 4).

The samples were removed via a Chemglass fine frit (4-5.5 μm) filter tube positioned above the thorium peroxide solid (FIG. 4). Samples were collected into six, 50 mL fractions. After mixing, 5 ml, of the sample was removed for gamma analysis, 1 mL removed and filtered through a 0.45 μm syringe filter for ICP-OES analysis and another 1 mL aliquot removed and unfiltered for ICP-OES analysis.

One-Gram Test #2

Synthesis

In a 100 mL, two-neck round bottom flask, 2.2322 g of ThCl₄.ₓ (1.0235 g of Th) was dissolved into 50 mL of 0.1 M NaNO₃. To the solution, 10 mL of 30% H₂O₂ was added while stirring. The pH was then adjusted with a KOH solution to pH=1.64. One hour was allowed for reaction time prior to beginning the rinse and filtering steps.

Sample Collection

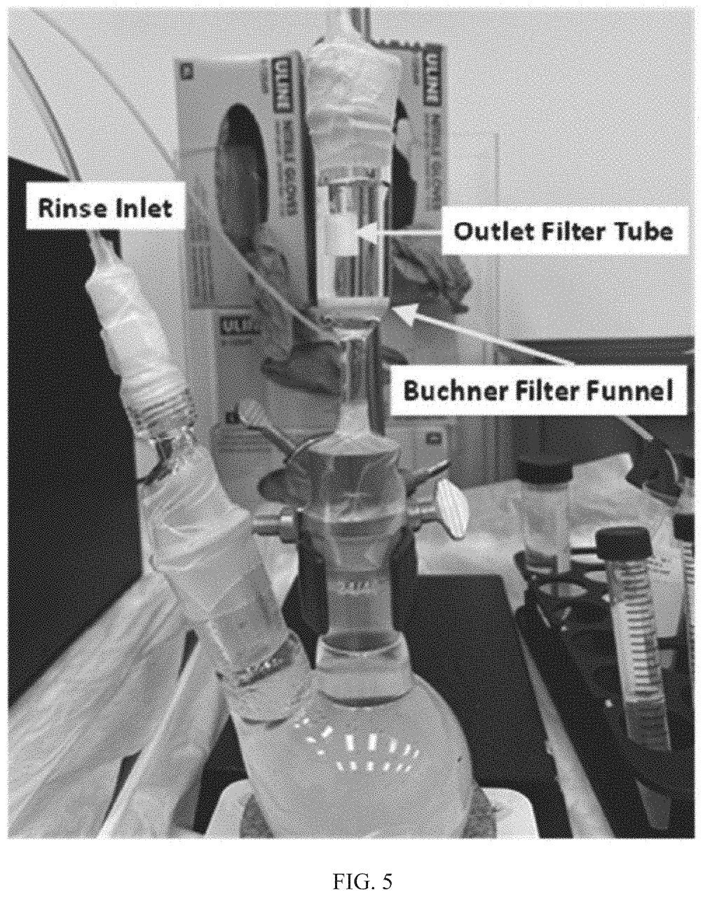

Filtering was achieved by increasing the volume of the solution, causing the solution to travel through a VWR medium (15-40 μm) frit, Buchner filter funnel (15 mL). Once the solution filtered through the primary (Buchner) filter, it was filtered a second time using a Chemglass fine frit (4-5.5 μm) filter tube. Again, the J-KEM dual syringe pump was utilized for the addition of pH=2.0 HNO₃ rinse solution and also for the removal of samples at 5 mL/min (FIG. 5).

Samples were collected into six, 50 mL fractions. After mixing, 5 mL of the sample was removed for gamma analysis, 1 mL removed and filtered through a 0.45 μm syringe filter for ICP-OES/MS analysis and another 1 mL aliquot removed and unfiltered for ICP-OES/MS analysis.

One-Gram Test #3

Synthesis

In a 100 mL round bottom flask, 2.3174 g of ThCl₄.ₓH₂O (1.0626 g of Th) was dissolved into 40 mL of 0.1 M NaNO₃. To the solution, 10 mL of 30% H₂O₂ was added while stirring. The pH was then adjusted with a KOH solution to pH=2.01. See section 5.2.2 for details on kinetics testing.

Transfer and Filtration Equipment

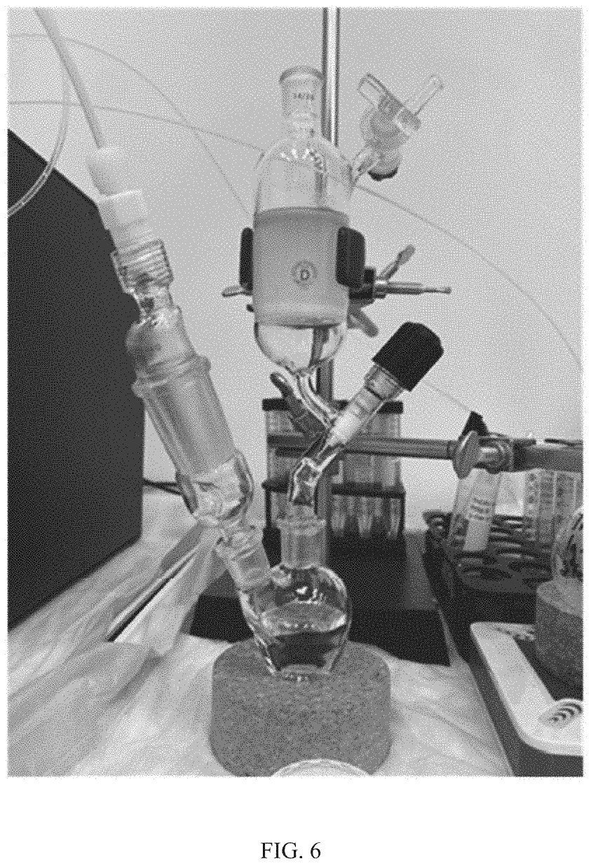

The following day the peroxide was transferred to 60 mL, 10-20 μm filter funnel, equipped with a bottom valve (AceGlass part #7776-25) via pipette. The filter was pre-wetted and filtering glassware rinsed with pH=2.0 HNO₃ solution. While loading the peroxide onto the filter, the bottom valve was closed to prevent solution flowing through the filter and allowing the solid to settle prior to filtering (FIG. 6).

Sample Collection

Once the solid had settled, the bottom valve was opened, and a slight vacuum applied via the J-KEM syringe pump (5 mL/min). Concurrently, the round bottom flask was rinsed three times with 10 mL of a pH=2.0 HNO₃ and added to the filtering apparatus. 50 mL was collected below the filter, into a 50 mL pear bottom flask. All of the easily available solution was removed during each filtering step. After collecting the 50 mL sample, the vacuum attachment was replaced by a Chemglass fine frit (4-5.5 μm) filter tube. The sample was removed from the pear bottom flask via the filter tube at a rate of 5 mL/min and transferred to a collection vial.

The remainder of rinse fractions were added via syringe pump at 5 mL/min. The rinse/filtering process was repeated 10 times with a pH=2.0 HNO₃ solution. After finishing collecting samples, the bottom valve was closed, and pH=2.0 solution was added to the peroxide to keep it wetted. After mixing, 5 mL of the sample was removed for gamma analysis, 1 mL removed and filtered through a 0.45 μm syringe filter for ICP-OES/MS analysis and another 1 mL aliquot removed and unfiltered for ICP-OES/MS analysis.

One-Gram Test #4 (0.4 M NaNO₃)

Synthesis

In a 100 mL round bottom flask, 2.3228 g of ThCL₄.ₓH₂O (1.0650 g of Th) was dissolved into 40 mL of 0.4 M NaNO₃. To the solution, 10 mL of 30% H₂O₂ was added while stirring. The pH was then adjusted with a KOH solution to pH=1.72. One hour was allowed for reaction time.

Transfer and Filtration Apparatus

Same transfer technique and filtering apparatus was used as is described for the One-Gram Test #3.

Sample Collection

Once the solid had settled, about 5-10 minutes, the bottom valve was opened, and a slight vacuum applied via the J-KEM syringe pump (5 mL/min). Solution was added to the peroxide until a volume of 50 mL was collected below the filter, into a 50 mL pear bottom flask. A surplus of solution volume was always added to the thorium peroxide (not allowing the peroxide to dry). After collecting the 50 mL, sample, the vacuum attachment was replaced by a Chemglass fine frit (4-5.5 μm) filter tube. The sample was removed from the pear bottom flask via the filter tube at a rate of 5 mL/min and transferred to a collection vial.

The rinse and filtering process was repeated 6 times with a 0.4 M NaNO₃ solution that was adjusted to pH=2.0. After finishing collecting samples, the bottom valve was closed and rinsing solution was added to the peroxide to keep it wetted. After mixing, 5 mL of the sample was removed for gamma analysis, 1 mL removed and filtered through a 0.45 μm syringe filter for ICP-OES/MS analysis and another 1 mL aliquot removed and unfiltered for ICP-OES/MS analysis.

One-Gram Test #5 (0.1 M NaNO₃)

Synthesis

In a 100 mL round bottom flask, 2.3340 g of ThCl₄.ₓH₂O (1.0702 g of Th) was dissolved into 40 mL of 0.1 M NaNO₃. To the solution, 10 ml, of 30% H₂O₂ was added while stirring. The pH was then adjusted with a KOH solution to pH=1.81. One hour was allowed for reaction time.

Transfer and Filtration Apparatus

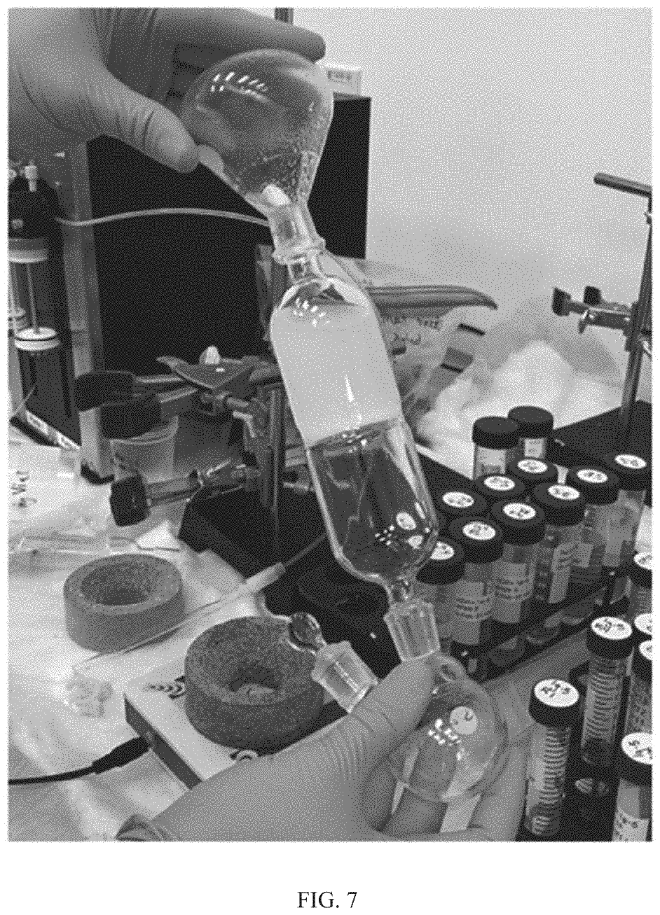

After one hour of reaction time the thorium peroxide was transferred by inverting the round bottom flask into a Chemglass 10-15 μm filter apparatus (FIG. 7).

Sample Collection

The sample collection procedure was similar to the procedure described in section [0087]. The rinse solution used for this experiment was 0.1 M NaNO₃ solution that was adjusted to pH=2.0.

One-Gram Test #6 (1.0 M NaNO₃)

Synthesis

To a 100 mL round bottom flask, 2.3342 g of ThCl₄.ₓH₂O (1.0703 g of Th) was dissolved into 40 mL of 1.0 M NaNO₃. To the solution, 10 mL of 30% H₂O₂ was added while stirring. The pH was then adjusted with a KOH solution to pH=1.81. One hour of reaction time was allowed.

Transfer and Filtering Apparatus

The same transfer method and filtering apparatus as described in the One-Gram Test #5 were used during this experiment.

Sample Collection

The sample collection procedure was similar to the procedure described in the One-Gram Test #5. The rinse solution used for this experiment was 1.0 M NaNO₃ solution that was adjusted to pH=2.0.

One-Gram Test #5 Repeat

Synthesis

In a 100 mL round bottom flask, 2.3470 g of ThCl₄.ₓH₂O (1.0761 g of Th) was dissolved into 40 mL of 0.1 M NaNO₃. To the solution, 10 mL of 30% H₂O₂ was added while stirring. The pH was then adjusted with a KOH solution to pH=1.94. One hour of reaction time was allowed.

Transfer and Filtration Apparatus

The method of transfer and filtration apparatus are described in section the One-Gram Test #3.

Sample Collection

The method for sample collection is described in the One-Gram Test #4.

One-Gram Test #7 (0.05 M NaNO₃)

Synthesis

Into a 100 mL round bottom flask, 2.3770 g of ThCl₄.ₓH₂O (1.0899 g of Th) was dissolved into 40 mL of 1.0 M NaNO₃. To the solution, 10 mL of 30% H₂O₂ was added while stirring. The pH was then adjusted with a KOH solution to pH=1.75. One hour of reaction time was allowed.

Transfer and Filtering Apparatus

The same transfer method and filtering apparatus as described in the One-Gram Test #5 were used during this experiment.

Sample Collection

The sample collection procedure was similar to the procedure described in the One-Gram Test #4. The rinse solution used for this experiment was 0.05 M NaNO₃ solution that was adjusted to pH=2.0.

2.5-Gram Test #1

Synthesis

In a 250 mL round bottom flask, 5.4676 g of ThCl₄.ₓH₂O (2.5070 g of Th) was dissolved in 60 mL of 0.1 M NaNO₃. To the solution, 25 mL of 30% H₂O₂ was added while stirring. The pH was then adjusted with a KOH solution to pH=1.76. Two hours of reaction time was allowed prior to transfer into the filtering apparatus.

Transfer and Filtration Apparatus

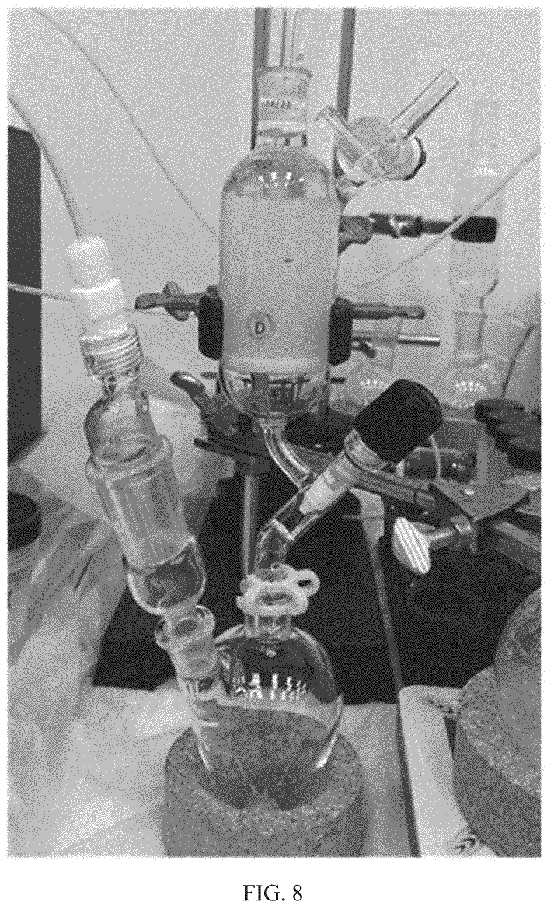

The method of transfer and filtration apparatus are described in the One-Gram Test #3 (FIG. 8).

Sample Collection

The method for sample collection is described in the One-Gram Test #4. Each rinsing solution volume was comprised of 48.3 mL of 0.1 M NaNO₃ and 1.7 mL of 30% H₂O₂. The pH of each rinse volume was measured prior to use. The rinse and filtering process was repeated 6 times.

Simulated Generator Cycling

1 g-4 Second Cycle

Initial Conditioning

The solid synthesized in One-Gram Test #4 (1 g-4), described above, was left in the filtering apparatus, undisturbed, for a total of 9 days. The pH1 of the thorium peroxide was determined to be pH=2.02 prior to the addition of any reactants. To the thorium peroxide, 10 mL of 30% H₂O₂ was added while gently agitating with a magnetic stir bar. After the addition of 30% H₂O₂ the solution phase pH=1.76.

Sample Collection

Approximately 40 minutes was allowed prior to the addition of 20 mL of pH=2.0, 0.1 M NaNO₃ solution at a rate of 5 mL/min. A slight vacuum of 5 mL/min was applied until a volume of 30 mL was filtered through the apparatus. After filtering through the primary filter was complete, the bottom valve was closed. Simultaneously, 30 mL of rinsing solution was added to the thorium peroxide while the vacuum attachment was removed and replaced with a Chemglass fine frit (4-5.5 μm) filter tube. The sample was removed from the pear bottom flask via the filter tube at a rate of 5 mL/min and transferred into a collection vial.

The rinse/filter cycle was repeated until six, 30 mL samples were collected. After mixing, 1 mL was removed and filtered through a 0.45 μm syringe filter for ICP-OES/MS analysis and another 1 mL aliquot removed and unfiltered for ICP-OES/MS analysis.

1 g-4 Third Cycle

The thorium peroxide synthesized in the One-Gram Test #4, and then subsequently rinsed in as described in 1 g-4 Second Cycle above, was used for this experiment after sitting undisturbed for four days.

Initial Conditioning

The pH of the thorium peroxide was determined to be pH=1.80 prior to the addition of any reactants. To the thorium peroxide, 10 mL of 30% H₂O₂ was added while gently agitating with a magnetic stir bar. After the addition of 30% H₂O₂ the solution phase pH=1.70.

The rinse fractions were prepared ahead of time, each containing 30 mL of 0.1 M NaNO₃, adjusted to pH=2.0 and 1 mL of 30% H₂O₂. The pH of each rinse fraction was determined to be between pH=1.88-2.05. Approximately, one hour was allowed for reaction time.

Sample Collection

To the filtration apparatus, 20 mL of pH=2.0, 0.1 M NaNO₃ solution at a rate of 5 mL/min. A slight vacuum of 5 mL/min was applied until a volume of 30 mL was filtered through the apparatus. After filtering through the primary filter was complete, the bottom valve was closed. Simultaneously, 30 mL of rinsing solution was added to the thorium peroxide while the vacuum attachment was removed and replaced with a Chemglass fine frit (4-5.5 μm) filter tube. The sample was removed from the pear bottom flask via the filter tube at a rate of 5 mL/min and transferred into a collection vial.

The rinse/filter cycle was repeated until six, 30 mL samples were collected. After mixing, 1 mL was removed and filtered through a 0.45 μm syringe filter for ICP-OES/MS analysis and another 1 mL aliquot removed and unfiltered for ICP-OES/MS analysis.

Gamma Spectroscopy

The isotope ²²⁸Ac has sufficient photopeaks for analysis by gamma spectroscopy (²²⁸Ra and ²²⁸Ac data below, data from IAEA isotope browser). The relevant decay is from ²³²Th to ²²⁸Th (t_{1/2}=1.91 years).

²³²Th→α+²²⁸Ra→β⁻+²²⁸Ac→²²⁸Th

The gamma data is collected to constant sample geometry. The decay is background corrected for the ²²⁸Ac regions of interest. The overall detector efficiency for the examined ²²⁸Ac photopeaks was determined with a known amount of ²³²Th (36.94 mg). The background correction and detector efficiency provide the activity in Bq from the collected spectroscopy data. The total activity in the collected sample was based on its 5 mL gamma analysis fraction.

The ²²⁸Ac present in a gamma sample is due to the original amount of separated ²²⁸Ac and the ingrowth of ²²⁸Ac from the decay of ²²⁸Ra. At any given time the activity of ²²⁸Ac is therefore related to the initial activity of ²²⁸Ac and ²²⁸Ra from growth and decay from:

²²⁸Acₜ=²²⁸Acₒe^{-λt}+²²⁸Raₒ(1−e^{-λt})

where ²²⁸Acₜ is the activity at time t, ²²⁸Acₒ is the initial ²²⁸Ac activity, ²²¹Raₒ is the initial ²²⁸Ra activity, λ is the decay constant for ²²⁸Ac, and t is the time between the separation and gamma activity measurement. The gamma output data contains the total counts, measurement time, and start time and is saved as RPT files.

The gamma spectroscopy was performed with 5 mL samples loaded on the gamma detector in the sample holder and set to count for 3600 seconds or until 1000 counts were collected at the 911 keV region of interest. The start time of each count was recorded for normalization to the time of separation. A job file was developed on ORTEC gamma analysis software to provide multiple sample datasets with variations in count time and labeling. This collected data was used to determine the amount of ²²⁸Ra and ²²⁸Ac at the time of separation. Multiple datapoints at times representing e^{-λt} from 0.9 to 0.05 were collected.

TABLE 1
Isotope Decay Modes and Relevant Gamma Data

| | | | | Relevant Gamma |
|---|---|---|---|---|
| | Half- | Decay | Decay | Data (Energy KeV, |
| Isotope | life | Mode | Constant (s⁻¹) | % yield) |
| ²²⁸Ra | 5.75 | β⁻ | 3.82E−09 | |
| | years | | | |
| ²²⁸Ac | 6.15 | β⁻ | 3.13E−05 | 338.3, 11.3 |
| | Hours | | | 911.2, 25.8 |
| | | | | 969.0, 15.8 |

Data Analysis

The collected data was copied from RPT files and transferred to Excel to be worked up. The time and date the load sample was added to the column was used as the start time of actinium and radium decay. This value was subtracted from the time and date of the gamma data collection for each sample to determine how much time has passed since the equilibrium between thorium, radium, and actinium was disturbed. From this the remaining amount of the initial actinium and the amount of actinium expected to have grown in from the radium was determined via the decay rate and growth and decay equations. Values for the initial ²²⁸Ra and ²²⁸Ac activity were determined by a least-squares fit to the experimental data.

ICP-OES and ICP-MS Analysis

ICP-OES

Sample Preparation

ICP-OES (optical emission spectroscopy) samples were prepared by taking a 1 mL aliquot of each sample collected and diluting with 9 mL of 2% nitric acid.

Instrumental Analysis

The diluted samples were loaded into the ICP-OES autosampler and analyzed. Calibration curves were created at the start of each run using thorium-232 standards ranging from 0.1 ppm to 50 ppm. The samples were analyzed at wavelengths 339.204 nm, 401.913 nm, and 274.716 nm using peak heights to determine the intensity at each wavelength.

TABLE 2
Perkin Elmer Optima 8000 ICP-OES Experimental Conditions

| | |
|---|---|
| Plasma gas flow (L/min) | 12.0 |
| Auxiliary gas flow (L/min) | 0.2 |
| Nebulizer gas flow (L/min) | 0.8 |
| RF power (Watts) | 1500 |
| Viewing height (mm) | 15 |
| Plasma view | Axial |
| Read parameters (s) | 1-5 |
| Peristaltic pump flow rate (mL/min) | 1.25 |
| Processing peak | Height |
| Calibration | Linear Calculated Intercept |

Data Analysis

The data collected from the ICP-OES was worked up in Excel. The concentrations of thorium in each sample at each wavelength was converted from molarity to grams and calculated to represent the total fraction. These values were then averaged to determine the amount of thorium in each sample as an average between the three wavelengths. The standard deviation between these values was also calculated and used to determine the error in each sample. Both of these values were divided by the theoretical starting amount of thorium to get the total amount of thorium recovered and in what part of the separation it was recovered in, as well as the error.

ICP-MS

Sample Preparation

ICP-OES (optical emission spectroscopy) samples were prepared by taking a 1 mL aliquot of each sample collected and diluting with 9 mL of 2% nitric acid.

Instrumental Analysis

The diluted samples were loaded into the ICP-MS autosampler and analyzed. Calibration curves were created at the start of each run using thorium-232 standards ranging from 0.1 ppb to 1.0 ppm. The samples were analyzed with and without He gas flow.

Data Analysis

The data collected from the ICP-MS was worked up in Excel. The concentrations of thorium in each sample, with and without He gas, was converted from molarity to grams and calculated to represent the total fraction. These values were then averaged to determine the amount of thorium in each sample as an average between the two detected values. The standard deviation between these values was also calculated and used to determine the error in each sample. Both of these values were divided by the theoretical starting amount of thorium to get the total amount of thorium recovered and in what part of the separation it was recovered in, as well as the error.

Results

All mentions of thorium, radium and actinium refer to ²³²Th, ²²⁸Ra and ²²⁸Ac, unless otherwise noted. “Ac %” and “Ra %” refers to the percent of the total mass of radium and actinium collected throughout the experiment. “BLD” means that the measurement was below the limit of detection for the instrument in use.

pH1 Range Study

The ICP-OES results (Table 3) indicated that above pH=1.0, only trace amounts of Th remain in the solution phase. The gamma results indicated that the bulk of the Ra and Ac remain in the solution phase below pH1=2.5.

TABLE 3
pH Range Study - ICP-OES and Gamma Results

| | Thorium Data | | | Actinium Data | | | Radium Data | | |
|---|---|---|---|---|---|---|---|---|---|
| | Th in | | | | ²²⁸Ac | | | ²²⁸Ra | |
| | Solution | SD | % Th in | Bq | error | ²²⁸Ac | Bq | error | ²²⁸Ra |
| pH | (mg) | (mg Th) | Solution | ²²⁸AC | (Bq) | % | ²²⁸Ra | (Bq) | % |
| 0.5 | 4.450 | 1.11E−02 | 16.240 ± 3.4E−04 | 124.93 | 4.92 | 107.11 | 126.48 | 4.34 | 108.44 |
| 1 | 0.070 | 1.90E−03 | 0.250 ± 1.9E−03 | 133.28 | 3.07 | 109.94 | 131.83 | 3.55 | 108.75 |
| 1.5 | BLD | N/A | BLD | 96.44 | 7.71 | 93.96 | 95.69 | 0.4 | 93.23 |
| 2 | BLD | N/A | BLD | 112.29 | 3.01 | 109.57 | 112.01 | 2.23 | 109.29 |
| 2.5 | BLD | N/A | BLD | 74.53 | 0.88 | 83.94 | 81.46 | 1.71 | 91.74 |
| 3 | BLD | N/A | BLD | 5.44 | 3.67 | 4.46 | 66.83 | 5.76 | 54.87 |

Kinetics Studies

The results of the kinetics studies suggest that the addition of NaNO₃ increases the kinetics of the reaction. One-gram results are based off of one test, duplicate tests are required to refine these data points.

TABLE 4
Kinetics Study - ICP-OES and Gamma Results

| | DI H2O | | | 0.1M NaNO₃ | | | One Gram Scale | | |
|---|---|---|---|---|---|---|---|---|---|
| | Th in | | | Th in | | | Th in | | |
| Time | Solution | SD | % Th in | Solution | SD | % Th in | Solution | SD | % Th in |
| (hr) | (mg) | (mg) | Solution | (mg) | (mg) | Solution | (μg) | (μg) | Solution |
| 0 | 19.968 | 1.4E−01 | 68.384 ± 4.9E−01 | 6.190 | 2.1 | 20.985 ± 7.2 | BLD | N/A | BLD |
| 0.25 | 19.450 | 1.6E−01 | 66.609 ± 5.4E−01 | BLD | N/A | BLD | N/A | N/A | N/A |
| 0.5 | 16.551 | 3.6E−02 | 56.681 ± 1.2E−01 | BLD | N/A | BLD | BLD | N/A | BLD |
| 0.75 | 10.181 | 1.5E−01 | 34.866 ± 5.1E−01 | BLD | N/A | BLD | N/A | N/A | N/A |
| 1 | 9.637 | 2.1E−01 | 33.002 ± 7.0E−01 | BLD | N/A | BLD | BLD | N/A | BLD |
| 2 | 2.010 | 3.0E−02 | 6.885 ± 1.0E−01 | N/A | N/A | N/A | BLD | N/A | BLD |
| 3 | 0.283 | 2.1E−03 | 0.969 ± 7.2E−03 | N/A | N/A | N/A | BLD | N/A | BLD |

Minimum Amount of 30% H₂O₂

Below are the ICP-OES results from aliquots removed from each sample. Results suggest that only 0.3 mL of 30% H₂O₂ is required for approximately 28 mg of Th to precipitate out of the solution phase.

TABLE 5
Minimum H₂O₂ - ICP-OES Results

| Amount | Th in | | |
|---|---|---|---|
| of H₂O₂ | Solution | SD | % Th in |
| (mL) | (mg) | (mg Th) | Solution |
| 0.1 | 0.176 | 3.7E−02 | 59.471 ± 13 |
| 0.2 | 0.049 | 1.1E−02 | 20.043 ± 4.5 |
| 0.3 | BLD | N/A | BLD |
| 0.4 | BLD | N/A | BLD |
| 0.5 | BLD | N/A | BLD |
| 0.6 | BLD | N/A | BLD |
| 0.7 | BLD | N/A | BLD |
| 0.8 | BLD | N/A | BLD |
| 0.9 | BLD | N/A | BLD |
| 1.0 | BLD | N/A | BLD |
| 1.1 | BLD | N/A | BLD |
| 1.2 | BLD | N/A | BLD |
| 1.3 | BLD | N/A | BLD |
| 1.4 | BLD | N/A | BLD |
| 1.5 | BLD | N/A | BLD |

Scale Up to 2.5 Grams—Liquid-Solid Separation Method—Increase Ion Concentration

Below are the results for each experiment performed to demonstrate the scalability of the thorium peroxide generator. Tests involving the variable methods utilized for liquid-solid separation and increased ion concentration, that were performed congruently with increasing the quantity of Th present, are also listed.

One-Gram Test #1 (1 g-1) Table 6

The results from 1 g-1 provided evidence that two stages of filtering, with the filtration apparatus used during this experiment, is necessary to separate all of the thorium from the solution phase. This is evident in the section of Table 3 denoted “One Filter Stage”. The data in the “Two Filter Stage” provided evidence that the thorium is not in the solution phase, leading us to the conclusion that solid particulates of thorium were able to migrate through the first filtering stage. The data for actinium and radium suggest that more rinse volumes were required to achieve a higher recovery.

One-Gram Test #2 (1 g-2) Table 7

The results form 1 g-2 suggested that two stages of filtering did help to retain more of the solid thorium, with recovery at 99.962±1.4·10⁻³% (note, after 100 extractions, 96.27% of the Th remains). The actinium and radium data suggest that continued rinsing is required to increase their recovery.

One-Gram Test #3 (1 g-3) Table 8

In response to the data collected in 1 g-2 shown in Table 7, the method of filtration was changed to “gravity” filtration method, instead of filing from above the solid, the solid was placed onto a filter and the solution collected from below. This was believed to increase the radium and actinium recovery while reducing the volumes of the eluent containing the radium and actinium. The results in Table 8, indicate that using this “gravity” filtration would increase the radium and actinium recovery. Unfortunately, the results for thorium indicated that thorium was, throughout the course of the experiment, dissolving into the solution phase. The dissolution of thorium is indicated by similar results in the apparatus and syringe filtered samples. The gradual increase of thorium in the solution phase indicates that during the course of the experiment, thorium was gradually dissolving into the solution phase.

One-Gram Test #4 (1 g-4) (0.4 M NaNO₃) Table 9

One gram test #4 begins testing with a range of ionic strengths, using 0.4 M NaNO₃ as an initial dissolution solution (dissolving ThCl₄) and as a rinsing solution. The results did not suggest that the addition of an increased ionic strength solution assisted in retaining the thorium in the solid phase. This again, is demonstrated by the gradual increase in the concentration of thorium in both the apparatus and syringe filtered samples. Radium and actinium yields remained high.

One-Gram Test #5 (1 g-5) (0.1 M NaNO₃) Table 10

1 g-5 utilized 0.1 M NaNO₃ as an initial dissolution solution (dissolving ThCl₄) and as a rinsing solution. Results indicate that thorium is dissolving into the solution throughout the course of the experiment. Radium recovery remained high while actinium data suggests that more rinses would be required to increase recovery.

One-Gram Test #6 (1 g-6) (1.0 M NaNO₃) Table 11

1 g-6 utilized 1.0 M NaNO₃ as an initial dissolution solution (dissolving ThCl₄) and as a rinsing solution. Results indicate that thorium is dissolving into the solution throughout the course of the experiment. Radium recovery remained high while actinium data suggests that more rinses would be required to increase recovery.

One Gram Test #5 Repeat (1 g-5 Repeat) Table 12

1 g-5 Repeat, repeated the conditions of 1 g-5, utilizing 0.1 M NaNO₃ as an initial dissolution solution (dissolving ThCl₄) and as a rinsing solution. Results indicate that thorium is dissolving into the solution throughout the course of the experiment. Radium recovery remained high while actinium data suggests that more rinses would be required to increase recovery.

One-Gram Test #7 (1 g-7) (0.05 M NaNO₃) Table 13

1 g-7 utilized 0.05 M NaNO₃ as an initial dissolution solution (dissolving ThCl₄) and as a rinsing solution. Results indicate that thorium is dissolving into the solution throughout the course of the experiment. Radium recovery remained high while actinium data suggests that more rinses would be required to increase recovery.

2.5-Gram Test #1 (2.5 g-1) Table 14

Utilizing the results learned in 1 g-4-Third Cycle (discussed below) 0.1 M NaNO₃ was used as a dissolution solution as well as a rinsing solution. To each 48.3 mL of 0.1 M NaNO₃ rinse aliquot, 1.7 mL of 30% H₂O₂ was added. The results in Table 11 demonstrate that 99.999% thorium retention is possible. While radium recovery remained high it is not understood why actinium yield decreased, as there is no expectation of actinium peroxide species formation. More testing is required to properly answer this question. It is also not clear why the first sample, which usually contains the lowest concentration of thorium, was the only sample which contained a detectable amount of thorium.

Simulated Generator Cycling

One-Gram Test #4—Second Cycle Table 15

The second cycle of 1 g-4 demonstrated that the addition of 30% H₂O₂, though only at the beginning of this experiment, drastically reduced the amount of thorium in the solution phase (see One-Gram Test #4 (1 g-4) (0.4 M NaNO₃) Table 9 above). Though the thorium continued to dissolve throughout the course of the experiment, this provided evidence that the addition of H₂O₂ throughout the course of the experiment may be necessary to keep thorium out of the solution phase.

One-Gram Test #4—Third Cycle Table 16

The third cycle of 1 g-4 included 1 mL of 30% H₂O₂ to each 30 mL of 0.1 M NaNO₃. The results demonstrate that thorium retention of 99.999% is possible with the current filtration apparatus. It is not clear why the first sample, which usually contains the lowest concentration of thorium, was the only sample which contained a detectable amount of thorium.

Summarized Recoveries Table 17

Table 17, below, summarizes the recoveries of thorium, radium, and actinium along with the experimental parameters.

TABLE 6
One Gram Test #1 - ICP-OES and Gamma Results

| | Thorium | | | | | | | | | |
|---|---|---|---|---|---|---|---|---|---|---|
| | One Filter Stage | | | Two Filter Stage | | | | | | |
| | | | % Th in | | | % Th in | | | | |
| | | | Solution | | | Solution | Actinium | | Radium | |
| | Th in | | Prior | Th in | | Post | | 228Ac | | 228Ra |
| Rinse | Solution | SD | Syringe | Solution | SD | Syringe | 228Ac | % | 228Ra | % |
| Fraction | (mg) | (mg Th) | Filter | (mg) | (mg Th) | Fiber | % | error | % | error |
| 1 | 0.267 | 0.041 | 0.026 ± 4.1E−03 | BLD | N/A | BLD | 18.13 | 1.41 | 21.63 | 1.09 |
| 2 | 2.807 | 0.127 | 0.276 ± 1.3E−02 | BLD | N/A | BLD | 19.25 | 0.08 | 17.92 | 1.15 |
| 3 | 4.005 | 0.183 | 0.394 ± 1.8E−02 | BLD | N/A | BLD | 18.32 | 1.81 | 17.53 | 0.18 |
| 4 | 4.585 | 0.214 | 0.451 ± 2.1E−02 | BLD | N/A | BLD | 17.93 | 0.21 | 16.08 | 0.49 |
| 5 | 3.265 | 0.138 | 0.321 ± 1.4E−02 | BLD | N/A | BLD | 17.22 | 1.00 | 18.19 | 0.49 |
| 6 | 6.189 | 0.323 | 0.609 ± 3.2E−02 | BLD | N/A | BLD | 9.15 | 0.29 | 8.66 | 0.39 |

Total Recovery

| | |
|---|---|
| Thorium: | 93.71 ± 8.1E−02% |
| Actinium: | 75.42 ± 3.62% |
| Radium: | 81.18 ± 3.08% |

Recovery After Syringe Fiber

| | |
|---|---|
| Thorium: | BLD (Assumed 100%) |

TABLE 7
One Gram Test #2 Data

| | Thorium | | | | | | | | | |
|---|---|---|---|---|---|---|---|---|---|---|
| | Apparatus Filtered Samples | | | Syringe Filtered Samples | | | Actinium | | Radians | |
| | Th in | | | Th in | | | | 228Ac | | 228Ra |
| Rinse | Solution | SD | % Th in | Solution | SD | % Th in | 228Ac | % | 228Ra | % |
| Fraction | (μg) | (μg Th) | Solution | (μg) | (μg Th) | Solution | % | error | % | error |
| 1 | 130.904 | 11.047 | 1.279E−02 ± 1.1E−03 | 110.308 | 7.108 | 1.078 ± 6.9E−04 | 22.30 | 4.72 | 22.94 | 0.76 |
| 2 | 79.456 | 4.898 | 7.763E−03 ± 4.8E−04 | 61.671 | 5.485 | 6.025E−03 ± 5.4E−04 | 20.96 | 4.70 | 21.01 | 0.38 |
| 3 | 24.936 | 1.236 | 2.436E−03 ± 1.2E−04 | 12.976 | 0.136 | 1.268E−03 ± 1.3E−05 | 23.17 | 7.30 | 20.41 | 3.30 |
| 4 | 49.933 | 2.901 | 4.879E−03 ± 2.8E−04 | 39.906 | 1.992 | 3.899E−03 ± 1.9E−04 | 18.18 | 1.52 | 20.77 | 0.97 |
| 5 | 104.626 | 6.341 | 1.022E−02 ± 6.2E−04 | 84.561 | 5.407 | 8.262E−03 ± 5.3E−04 | 15.40 | 3.87 | 14.87 | 2.18 |

Total Recovery

| | |
|---|---|
| Thorium: | 99.962 ± 2.7E−04% |
| Actinium: | 38.84 ± 8.59% |
| Radium: | 40.67 ± 3.09% |

Recovery After Syringe Filter

| | |
|---|---|
| Thorium: | 99.970 ± 1.0E−03% |

TABLE 8
One Gram Test #3 - ICP-OES and Gamma Results

| | Thorium | | | | | | | | | |
|---|---|---|---|---|---|---|---|---|---|---|
| | Apparatus Filtered Samples | | | Syringe Filtered Samples | | | Actinium | | Radium | |
| | Th in | | | Th in | | | | ²²⁸Ac | | ²²⁸Ra |
| Rinse | Solution | SD | % Th in | Solution | SD | % Th in | ²²⁸Ac | % | ²²⁸Ra | % |
| Fraction | (mg) | (mg Th) | Solution | (mg) | (mg Th) | Solution | % | error | % | error |
| 1 | BLD | N/A | BLD | BLD | N/A | BLD | 43.63 | 2.09 | 43.63 | 2.09 |
| 2 | BLD | N/A | BLD | BLD | N/A | BLD | 43.00 | 0.88 | 43.00 | 0.88 |
| 3 | 3.319E−03 | 4.180E−05 | 2.964E−04 ± 3.9E−06 | 3.1494E−03 | 4.1804E−05 | 2.964E−04 ± 3.9E−06 | 9.04 | 0.46 | 9.04 | 0.46 |
| 4 | 8.459 | 7.269 | 0.796 ± 0.684 | 7.693 | 6.658 | 0.724 ± 0.6 | 1.98 | 0.12 | 1.98 | 0.12 |
| 5 | 23.289 | 20.185 | 2.192 ± 1.9 | 73.874 | 82.711 | 6.952 ± 7.8 | 1.13 | 0.14 | 1.13 | 0.14 |
| 6 | 31.588 | 27.343 | 2.973 ± 2.6 | 28.757 | 24.897 | 2.706 ± 2.3 | 0.75 | 0.27 | 0.75 | 0.27 |
| 7 | 32.701 | 28.326 | 3.077 ± 2.7 | 27.824 | 24.092 | 2.618 ± 2.3 | 0.14 | 0.10 | 0.14 | 0.10 |
| 8 | 53.517 | 8.014 | 5.036 ± 0.8 | 23.458 | 39.471 | 2.208 ± 3.7 | 0.14 | 0.20 | 0.14 | 0.20 |
| 9 | 32.682 | 28.314 | 3.076 ± 2.7 | 28.580 | 24.757 | 2.689 ± 2.3 | 0.15 | 0.05 | 0.15 | 0.05 |
| 10 | 28.559 | 24.752 | 2.688 ± 2.3 | 25.316 | 21.938 | 2.382 ± 2.1 | 0.05 | 0.06 | 0.05 | 0.06 |
| 11 | 45.358 | 39.286 | 4.269 ± 3.7 | 42.150 | 36.528 | 3.967 ± 3.4 | N/A | N/A | N/A | N/A |

Total Recovery

| | |
|---|---|
| Thorium: | 75.893 ± 0.3% |
| Actinium: | 98.28 ± 4.3% |
| Radium: | 98.28 ± 4.3% |

Recovery After Syringe Filter

| | |
|---|---|
| Thorium: | 75.752 ± 0.18% |

*Counts started one day after separation, Data analysis assumes ²²⁸Ra and ²²⁸Ac activity equal

TABLE 9
One Gram Test #4 (0.4M NaNO₃) - ICP-OES and Gamma Results

| | Thorium | | | | | | | | | |
|---|---|---|---|---|---|---|---|---|---|---|
| | Apparatus Filtered Samples | | | Syringe Filtered Samples | | | Actinium | | Radium | |
| | Th in | | | Th in | | | | ²²⁸Ac | | ²²⁸Ra |
| Rinse | Solution | SD | % Th in | Solution | SD | % Th in | ²²⁸Ac | % | ²²⁸Ra | % |
| Fraction | (mg) | (mg Th) | Solution | (mg) | (mg Th) | Solution | % | error | % | error |
| 1 | 0.240 | 0.140 | 0.023 ± 0.01 | 0.194 | 0.127 | 0.018 ± 0.1 | 59.36 | 2.68 | 60.13 | 4.10 |
| 2 | 0.783 | 0.143 | 0.073 ± 0.01 | 0.699 | 0.148 | 0.066 ± 0.01 | 26.59 | 1.22 | 33.88 | 2.08 |
| 3 | 30.466 | 1.154 | 2.861 ± 0.1 | 35.388 | 1.289 | 3.323 ± 0.1 | 6.22 | 0.74 | 5.03 | 0.94 |
| 4 | 58.996 | 1.514 | 5.539 ± 0.1 | 67.865 | 1.722 | 6.372 ± 0.2 | 4.34 | 1.37 | 0.86 | 0.52 |
| 5 | 116.076 | 3.366 | 10.899 ± 0.3 | 108.060 | 2.946 | 10.899 ± 0.3 | 1.66 | 0.74 | 0.08 | 0.15 |
| 6 | 130.728 | 5.562 | 12.275 ± 0.5 | 135.425 | 4.434 | 12.716 ± 0.4 | 1.83 | 0.77 | 0.02 | 0.04 |

Total Recovery

| | |
|---|---|
| Thorium: | 68.330 ± 0.6% |
| Actinium: | 92.50 ± 7.0% |
| Radium: | 106.95 ± 8.4% |

Recovery After Syringe Filter

| | |
|---|---|
| Thorium: | 67.359 ± 0.54% |

TABLE 10
One Gram Test #5 (0.1M NaNO₃) - ICP-OES and Gamma Results

| | Thorium | | | | | | | | | |
|---|---|---|---|---|---|---|---|---|---|---|
| | One Filter Stage | | | Two Filter Stage | | | Actinium | | Radium | |
| | Th in | | | Th in | | | | ²²⁸Ac | | ²²⁸Ra |
| Rinse | Solution | SD | % Th in | Solution | SD | % Th in | ²²⁸Ac | % | ²²⁸Ra | % |
| Fraction | (mg) | (mg Th) | Solution | (mg) | (mg Th) | Solution | % | error | % | error |
| 1 | BLD | N/A | BLD | BLD | N/A | BLD | 40.77 | 0.25 | 38.33 | 2.01 |
| 2 | BLD | N/A | BLD | BLD | N/A | BLD | 14.34 | 0.36 | 14.51 | 0.20 |
| 3 | BLD | N/A | BLD | BLD | N/A | BLD | 17.07 | 0.56 | 20.80 | 0.93 |
| 4 | 1.344 | 0.064 | 0.125 ± 5.9E−03 | 1.220 | 0.071 | 0.114 ± 6.6E−03 | 8.18 | 0.63 | 16.19 | 0.04 |
| 5 | 19.095 | 0.789 | 1.784 ± 7.4E−02 | 17.005 | 0.483 | 1.589 ± 4.5E−02 | 12.33 | 10.97 | 10.18 | 1.49 |
| 6 | 35.669 | 0.965 | 3.333 ± 9.0E−02 | 29.332 | 1.293 | 2.741 ± 0.12 | 7.32 | 0.42 | 0.00 | 0.00 |

Total Recovery

| | |
|---|---|
| Thorium: | 94.757 ± 0.11% |
| Actinium: | 76.45 ± 10.09% |
| Radium: | 109.78 ± 5.13% |

Recovery After Syringe Filter

| | |
|---|---|
| Thorium: | 95.556 ± 0.13% |

TABLE 11
One Gram Test #6 (1.0M NaNO₃) - ICP-OES and Gamma Results

| | Thorium | | | | | | | | | |
|---|---|---|---|---|---|---|---|---|---|---|
| | Apparatus Filtered Samples | | | Syringe Filtered Samples | | | Actinium | | Radium | |
| | Th in | | | Th in | | | | ²²⁸Ac | | ²²⁸Ra |
| Rinse | Solution | SD | % Th in | Solution | SD | % Th in | ²²⁸Ac | % | ²²⁸Ra | % |
| Fraction | (mg) | (mg Th) | Solution | (mg) | (mg Th) | Solution | % | error | % | error |
| 1 | BLD | N/A | BLD | BLD | N/A | BLD | 20.38 | 1.01 | 30.46 | 2.26 |
| 2 | BLD | N/A | BLD | BLD | N/A | BLD | 16.80 | 0.74 | 33.72 | 0.96 |
| 3 | 1.991 | 0.069 | 0.186 ± 6.5E−03 | 1.868 | 0.097 | 0.174 ± 9.0E−03 | 26.80 | 1.86 | 31.16 | 1.15 |
| 4 | 44.569 | 2.974 | 4.164 ± 0.28 | 44.883 | 2.365 | 4.193 ± 0.22 | 19.64 | 0.36 | 3.74 | 0.11 |
| 5 | 110.640 | 6.731 | 10.337 ± 0.63 | 95.374 | 3.507 | 8.911 ± 0.33 | 10.17 | 0.63 | 0.87 | 0.64 |
| 6 | 132.933 | 4.875 | 12.420 ± 0.46 | 144.199 | 9.788 | 13.473 ± 0.91 | 6.22 | 0.18 | 0.06 | 0.10 |

Total Recovery

| | |
|---|---|
| Thorium: | 46.139 ± 0.82% |
| Actinium: | 66.84 ± 3.19% |
| Radium: | 104.11 ± 5.43% |

Recovery After Syringe Fiber

| | |
|---|---|
| Thorium: | 73.245 ± 1.0% |

TABLE 12
One Gram Test #5 Repeat (0.1M NaNO₃) - ICP-OES and Gamma Results

| | Thorium | | | | | | | | | |
|---|---|---|---|---|---|---|---|---|---|---|
| | Apparatus Filtered Samples | | | Syringe Filtered Samples | | | Actinium | | Radium | |
| | Th in | | | Th in | | | | ²²⁸Ac | | ²²⁸Ra |
| Rinse | Solution | SD | % Th in | Solution | SD | % Th in | ²²⁸Ac | % | ²²⁸Ra | % |
| Fraction | (mg) | (mg Th) | Solution | (mg) | (mg Th) | Solution | % | error | % | error |
| 1 | BLD | N/A | BLD | BLD | N/A | BLD | 51.44 | 2.36 | 52.08 | 5.20 |
| 2 | BLD | N/A | BLD | BLD | N/A | BLD | 32.97 | 1.51 | 43.36 | 1.04 |
| 3 | 2.632 | 0.037 | 0.244 ± 3.5E−03 | 2.227 | 0.017 | 0.207 ± 1.6E−03 | 7.22 | 2.66 | 0.00 | N/A |
| 4 | 10.306 | 0.063 | 0.958 ± 5.9E−03 | 7.357 | 0.042 | 0.684 ± 3.9E−03 | 5.29 | 1.00 | 1.67 | 1.84 |
| 5 | 17.690 | 0.165 | 1.644 ± 1.5E−02 | 16.373 | 0.412 | 1.522 ± 3.8E−02 | 1.07 | 1.86 | 1.86 | 1.78 |
| 6 | 29.434 | 0.270 | 2.734 ± 2.5E−02 | 26.834 | 0.315 | 2.494 ± 2.9E−02 | 2.01 | 0.85 | 1.03 | 0.89 |

Total Recovery

| | |
|---|---|
| Thorium: | 94.389 ± 0.03% |
| Actinium: | 69.88% ± 7.2% |
| Radium: | 101.02% ± 10.9% |

Recovery After Syringe Filter

| | |
|---|---|
| Thorium: | 95.093 ± 0.05% |

TABLE 13
One Gram Test #7 (0.05M NaNO₃) - ICP-OES and Gamma Results

| | Thorium | | | | | | | | | |
|---|---|---|---|---|---|---|---|---|---|---|
| | Apparatus Filter Samples | | | Syringe Filtered Samples | | | Actinium | | Radium | |
| | Th in | | | Th in | | | | ²²⁸Ac | | ²²⁸Ra |
| Rinse | Solution | SD | % Th in | Solution | SD | % Th in | ²²⁸Ac | % | ²²⁸Ra | % |
| Fraction | (mg) | (mg Th) | Solution | (mg) | (mg Th) | Solution | % | error | % | error |
| 1 | BLD | N/A | BLD | BLD | N/A | BLD | 52.56 | 3.34 | 47.94 | 1.11 |
| 2 | BLD | N/A | BLD | BLD | N/A | BLD | 33.97 | 0.52 | 38.25 | 0.69 |
| 3 | 1.138 | 0.525 | 0.104 ± 4.8E−02 | 0.654 | 0.514 | 0.060 ± 4.7E−02 | 8.13 | 0.78 | 12.21 | 0.75 |
| 4 | 71.225 | 1.203 | 6.535 ± 0.11 | 52.251 | 0.801 | 4.794 ± 7.3E−02 | 2.20 | 0.16 | 1.26 | 0.24 |
| 5 | 136.455 | 2.271 | 12.520 ± 0.21 | 86.934 | 1.351 | 7.976 ± 0.12 | 1.68 | 0.29 | 0.30 | 0.11 |
| 6 | 138.712 | 1.644 | 12.727 ± 0.15 | 91.896 | 1.226 | 8.432 ± 0.11 | 1.46 | 0.07 | 0.04 | 0.06 |

Total Recovery

| | |
|---|---|
| Thorium: | 68.098 ± 0.29% |
| Actinium: | 86.24 ± 4.45% |
| Radium: | 102.36 ± 3.02% |

Recovery After Syringe Filter

| | |
|---|---|
| Thorium: | 78.762 ± 0.20% |

TABLE 14
2.5 Gram Test #1 - ICP-MS and Gamma Results

| | Thorium | | | | | | | | | |
|---|---|---|---|---|---|---|---|---|---|---|
| | Apparatus Filtered Samples | | | Syringe Filtered Samples | | | Actinium | | Radium | |
| | Th in | | | Th in | | | | ²²⁸Ac | | ²²⁸Ra |
| Rinse | Solution | SD | % Th in | Solution | SD | % Th in | ²²⁸Ac | % | ²²⁸Ra | % |
| Fraction | (μg) | (μg Th) | Solution | (μg) | (μg Th) | Solution | % | error | % | error |
| 1 | 56.603 | 0.343 | 2.258E−03 ± 1.4E−05 | 27.768 | 2.867 | 1.108E-03 ± 1.1E−04 | 36.47 | 1.20 | 33.91 | 4.18 |
| 2 | BLD | N/A | BLD | BLD | N/A | BLD | 33.53 | 0.77 | 36.03 | 1.17 |
| 3 | BLD | N/A | BLD | BLD | N/A | BLD | 19.85 | 2.17 | 24.35 | 1.15 |
| 4 | BLD | N/A | BLD | BLD | N/A | BLD | 6.91 | 0.64 | 3.33 | 2.19 |
| 5 | BLD | N/A | BLD | BLD | N/A | BLD | 3.24 | 0.56 | 0.47 | 0.81 |
| 6 | BLD | N/A | BLD | BLD | N/A | BLD | 0.00 | N/A | 1.91 | 0.07 |

Total Recovery

| | |
|---|---|
| Thorium: | 99.998 ± 1.3E−03% |
| Actinium: | 54.01 ± 2.88% |
| Radium: | 98.10 ± 9.39% |

Recovery With Second Filter

| | |
|---|---|
| Thorium: | 99.999 ± 1.1E−04% |

TABLE 15
One Gram Test #4 - Second Cycle - ICP-OES and Gamma Results

| | Second Rinse | | | | | |
|---|---|---|---|---|---|---|
| | Apparatus Filtered Samples | | | Syringe Filtered Samples | | |
| | Th in | | % Th in | Th in | | |
| Rinse | Solution | SD | Solution | Solution | SD | % Th in |
| Fraction | (mg) | (mg Th) | Prior | (mg) | (mg Th) | Solution |
| 1 | 2.838 | 0.118 | 0.266 ± 0.01 | 0.353 | 0.026 | 0.033 ± 2.5E−03 |
| 2 | 0.361 | 0.029 | 0.034 ± 2.7E−03 | 0.282 | 0.024 | 0.026 ± 2.3E−03 |
| 3 | 2.722 | 0.085 | 0.256 ± 8.0E−03 | 2.525 | 0.098 | 0.237 ± 9.2E−03 |
| 4 | 14.848 | 0.133 | 1.394 ± 1.3E−02 | 13.328 | 0.142 | 1.251 ± 1.3E−02 |
| 5 | 33.667 | 0.788 | 3.161 ± 7.4E−02 | 30.933 | 0.629 | 2.904 ± 5.9E−02 |
| 6 | 24.847 | 0.188 | 2.333 ± 1.8−02 | 22.976 | 0.356 | 2.157 ± 3.3E−02 |

Total Recovery Second Rinse

| | |
|---|---|
| Thorium: | 92.556 ± 8.0E−02% |

Recovery After Syringe Filter

| | |
|---|---|
| Thorium: | 93.276 ± 0.07% |

TABLE 16
Summarized Recoveries of Th, Ra and Ac

| | | | | | | | | | Volume |
|---|---|---|---|---|---|---|---|---|---|
| | | | | | | | | | of 1.0M |
| | | | | | | | Dissolution | Volume | KOH |
| | Thorium | Actinium | Radium | | | Rinse | Volume | of H₂O₂ | Added |
| Test ID | Recovery | Recovery | Recovery | Th (g) | pH | Solution | (mL) | (mL) | (mL) |
| 1g-1 | 93.71% ± .0806 | 75.42% ± 3.62 | 81.18% ± 3.08 | 1.0159 | 1.64 | pH = 2.0 HNO₃ | 40.00 | 10.00 | 1.43 |
| 1g-2 | 99.962% ± 2.7E−04 | 38.84% ± 8.59 | 40.67% ± 3.09 | 1.0235 | 1.64 | pH = 2.0 HNO₃ | 50.00 | 10.00 | 12.00 |
| 1g-3 | 75.893 ± 0.3% | 98.28 ± 4.3% | 98.28 ± 4.3% | 1.0626 | 2.01 | pH = 2.0 HNO₃ | 40.00 | 10.00 | 11.00 |
| 1g-4 | 68.330 ± 0.6% | 92.50 ± 7.0% | 106.95 ± 8.4% | 1.0650 | 1.72 | 0.4M NaNO₃ | 40.00 | 10.00 | 12.50 |
| 1g-5 | 94.757 ± 0.11% | 76.45 ± 10.09% | 109.78 ± 5.13% | 1.0702 | 1.81 | 0.1M NaNO₃ | 40.00 | 10.00 | 10.00 |
| 1g-6 | 46.139 ± 0.82% | 66.84 ± 3.19% | 104.11 ± 5.43% | 1.0703 | 1.87 | 1.0M NaNO₃ | 40.00 | 10.00 | 12.00 |
| 1g-7 | 68.098 ± 0.29% | 86.24 ± 4.45% | 102.36 ± 3.02% | 1.0899 | 1.75 | 0.05M NaNO₃ | 40.00 | 10.00 | 12.00 |
| 1g-5 | 94.389 ± 0.03% | 69.88% ± 7.2% | 101.02% ± 10.9% | 1.0761 | 1.94 | 0.1M NaNO₃ | 40.00 | 10.00 | 12.00 |
| Repeat | | | | | | | | | |
| 2.3g-1 | 99.998 ± 1.3E−03% | 54.01 ± 2.88% | 98.10 ± 9.39% | 2.5070 | 1.62 | 0.1M NaNO₃ | 60.00 | 25.00 | 37.00 |
| | | | | | | and H₂O₂ | | | |
| 1g-4 | 92.556 ± 8.0E−02% | N/A | N/A | 1.0650 | 2.02 | 0.1M NaNO₃ | N/A | 10.00 | N/A |
| Second | | | | | | | | | |
| Cycle | | | | | | | | | |
| 1g-4 | 99.998 ± 8.0E−05% | N/A | N/A | 1.0650 | 1.80 | 0.1M NaNO₃ | N/A | 10.00 | N/A |
| Third | | | | | | and H₂O₂ | | | |
| Cycle | | | | | | | | | |

### DISCUSSION

All mentions of thorium, radium and actinium refer to ²³²Th, ²²⁸Ra and ²²⁸Ac, unless otherwise noted.

pH Range

Initial testing determining a pH range in which Th precipitates out of the solution phase and Ra and Ac remain in the solution phase provided the working range for the remainder of experiments, pH=1.0-2.0 with a primary focus on pH=1.5-2.0 (Table 1). As demonstrated by these results (Table 3), close to 100% of the radium and actinium may be separated from the partitioned thorium. This range may have the potential of expanding to pH=1, with more research, to fit experimental parameters. It should be noted that the pH range has not been re-tested since increasing the ion concentration of the dissolving solution.

Kinetics

The kinetics studies provided insight into the length of time required for the initial synthetic step. Though only one study was conducted at the one-gram scale, results indicate that this step may be completed in less than one hour. The results from other one gram scale experiments indicate that one hour of reaction time is sufficient, indicated by thorium concentration in the solution phase being below the limit of detection. The addition of hydrogen peroxide prior to rinsing and any kinetics involved have not been thoroughly investigated but initial results have demonstrated that this step may also be completed under one hour.

Minimum Amount of 30% H₂O₂

Results indicate, at the 50-70 mg scale, that five times excess 30% H₂O₂ was used for most experiments and approximately two times excess for one gram and 2.5 gram experiments. This provides some margin for a reduction in the amount of 30% H₂O₂ that is required.

Scale up to 2.5 Grams—Liquid-Solid Separation Method—Increase Ion Concentration

The results indicate that it is possible to retain 99.999% of the thorium (Tables 11 and 13). Results from 2.5 g-1 may be hindered by residual thorium on the filtration equipment, as it had been used in several pervious experiments. Radium recovery remained high consistently.

Increasing the ionic strength of the rinsing solution, above or below 0.1 M NaNO₃ did not seem to have an effect on the retention of thorium in the solid phase. This testing was conducted prior to demonstrating that additional 30% H₂O₂ was helpful while rinsing to keep the thorium in the solid phase.

The first filtration method, filtering the solution phase from the top, was investigated due to the fact that the thorium peroxide would remain in non-porous glassware. The side effect of this method was increased rinse volumes that would be necessary to remove all of the radium and actinium. The method utilizing “gravity” filtration, demonstrated that the bulk of the radium and actinium can be separated in the first 4 to 5, 50 mL, rinse volumes (Tables 8 and 9). As previously mentioned, it was also demonstrated that thorium retention is not as difficult as previously thought.

Simulated Generator Cycling

Results indicate that the thorium peroxide solid may be left on the filtration apparatus for an extended period of time (9 days was the maximum amount of time afforded by this experiment). The pH remained stable during the storage period, indicating that no substantial chemical changes had taken place during the storage period. The addition of hydrogen peroxide prior to rinsing and any kinetics involved have not been thoroughly investigated but have produced favorable results thus far. Likewise, the amount of hydrogen peroxide added to each rinse volume have produced favorable results.

### CONCLUSIONS

All mentions of thorium, radium and actinium refer to ²³²Th, ²²⁵Ra and ²²⁸Ac.

The results of these studies indicate that the precipitation of thorium peroxide at pH=1.5-2.0, is a means for the chemical separation of thorium from radium and actinium. Thorium retention at or above 99.998% has been demonstrated and can be expected in future experimentation. Results indicate that the addition of 30% H₂O₂ to each rinse is helpful to maintain the thorium in the solid phase. Results also indicate that an increased ion concentration does not appear to have an effect on maintaining thorium in the solid phase. It is possible that the added [NO₃⁻] may be interfering with actinium recovery.

Vacuum filtration, at this point, appears to be the most efficient method of solid—liquid separation. All experimentation was conducted with “off the shelf” glassware, which demonstrates the simplicity of the separation scheme. Customized glassware may assist in improved results and further simplification of the procedure.

Initial experimentation demonstrated that close to 100% of the radium and actinium may be recovered from the partitioned thorium. Large scale (one gram) experiments demonstrated that the bulk of the radium and actinium may be recovered in the first four to five, 50 mL rinses. Radium recovery remained high throughout experimentation, but further investigation is required to determine how actinium behaves at large scale.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

Notwithstanding the appended claims, the disclosure is also defined by the following clauses:

1. A method for generating ²²⁵Ac and ²²⁵Ra from ²²⁹Th comprising:

providing a first suspension of solid ²²⁹Th peroxide with a cover liquid solution;

storing the first suspension for a first period of time during which at least some ²²⁹Th decays into ²²³Ac; and

separating the solid ²²⁹Th peroxide from at least some of the cover liquid solution of the first suspension to obtain a quantity of separated solid ²²⁹Th peroxide and a first liquid solution containing at least some ²⁵Ac.

2. The method of clause 1 further comprising:

after separating the solid ²²⁹Th peroxide from the cover liquid, adding an amount of fresh cover liquid to the separated solid ²²⁹Th peroxide to create a second suspension.

3. The method of clause 2 further comprising:

storing the second suspension for a second period of time during which at least some ²²⁹Th decays into ²²⁵Ac; and

separating the solid ²²⁹Th peroxide from at least some of the cover liquid solution of the second suspension to obtain a quantity of separated solid ²²⁹Th peroxide and a second liquid solution containing at least some ²²⁵Ac.

4. The method of any of clauses 1-3 wherein separating the solid ²²⁹Th peroxide from the cover liquid solution further comprises:

agitating the first suspension or the second suspension prior to separating the solid ²²⁹Th peroxide from the cover liquid solution.

5. The method of any of clauses 1-4 wherein separating the solid ²²⁹Th peroxide from the cover liquid solution further comprises:

maintaining an excess amount of peroxide in the cover liquid solution.

6. The method of clause 5, wherein maintaining an excess amount of peroxide in the cover liquid solution comprises:

adding a H₂O₂ solution to the first suspension or the second suspension prior to separating the solid ²²⁹Th peroxide from the cover liquid solution.

7. The method of clause 6, wherein the H₂O₂ solution is from 5% to 50% by weight H₂O₂.

8. The method of clause 6, wherein the H₂O₂ solution is from 25% to 35% by weight H₂O₂.

9. The method of any of clauses 1-8, wherein providing the first suspension comprises:

dissolving an amount of 2⁹ThCl₄.ₓH₂O or ²²⁹Th(NO₃)₄.ₓH₂O in an acid solution to obtain a dissolved ²²⁹Th solution; and

adding an amount of H₂O₂ to the dissolved ²²⁹Th solution thereby forming solid ²²⁹Th peroxide and a residue liquid phase;

separating the solid ²²⁹Th peroxide from the residue liquid phase; and

adding the solid ²²⁹Th peroxide to an acidic cover liquid solution to create the first suspension.

10. The method of any of clauses 1-9, wherein separating the solid ²²⁹Th peroxide from the cover liquid solution includes one or more of filtering, centrifuging, and gravity settling.

11. The method of any of clauses 1-10, wherein the cover liquid solution is a NaNO₃ liquid solution.

12. The method of clause 11, wherein the cover liquid solution is a NaNO₃ solution of from 0.01 to 10.0 M NaNO₃.

13. The method of any of clauses 1-10, wherein the cover solution is a HNO₃ solution.

14. The method of clause 13, wherein the cover liquid solution is a HNO₃ solution of from 0.01 to 10.0 M HNO₃.

15. The method of any of clauses 1-14, wherein the first period of time is 25 days or less.

16. The method of any of clauses 1-14, wherein the first period of time is 10 days or less.

17. The method of any of clauses 1-16, wherein the second period of time is 25 days or less.

18. The method of any of clauses 1-16, wherein the second period of time is 10 days or less.

19. The method of any of clauses 1-18, further comprising:

maintaining the first suspension and/or the second suspension at a pH from 0.5 to 3.

20. The method of any of clauses 1-18, further comprising:

maintaining the first suspension and/or the second suspension at a pH of from 1.5 to 2.0.

21. The method of clause 19 or 20, wherein maintaining the first suspension and the second suspension at a pH from 0.5 to 3 further comprises:

adding a solution of either KOH or HNO₃ as needed to the first suspension or the second suspension.

22. A system for generating ²²⁵Ac and ²²⁵Ra from ²²⁹Th comprising:

a vessel containing a suspension of solid ²²⁹Th peroxide with a cover liquid.

23. The system of clause 22, wherein the first vessel is a filter funnel.

24. The system of clause 22, wherein the cover liquid is a NaNO₃ liquid solution.

25. The system of clause 22, wherein the cover liquid is a HNO₃ liquid solution.

26. A ²²⁵Ac generator, comprising:

a first portion of the generator;

a column body defining an interior chamber;

a first access port at the first portion of the generator providing access to the interior chamber; and

an amount of solid ²²⁹Th peroxide contained in the interior chamber.

27. The generator of clause 26, further comprising:

a suspension of solid ²²⁹Th peroxide with a liquid phase storage solution.

28. The generator of clause 27, wherein the liquid phase storage solution is selected from an NaNO₃ liquid solution and a HNO₃ liquid solution.

29. The generator of any of clauses 26-28, further comprising:

a second portion of the generator; and

a second access port at the second portion of the generator,

wherein:
the first portion of the generator is a top portion of the generator;
the first access port is an upper valve;
the second portion of the generator is a bottom portion of the generator; and
the second access port is a bottom valve or a u-tube.

30. The generator of any of clauses 26-29, wherein the interior chamber includes a filter to prevent the solid ²²⁹Th peroxide from removal via at least one of the first access port or the second access port.

31. The generator of any one of clauses 26-30, wherein the column body is one of capsule-shaped (spherocylindrical), cylindrical, spherical, conical, pyramidal, frustoconical, or frustopyramidal.

32. The generator of any one of clauses 26-31, wherein the first portion and the second portion form a seal to the interior chamber.

33. The generator of any one of clauses 26-32, wherein the first portion and the second portion are removably attached to the column body.

34. The generator of any one of clauses 26-33, wherein the first portion, the column body and the second portion are integrally formed.

35. The generator of any one of clauses 26-34, further comprising a third sealable access port.

36. The generator of any one of clauses 26-35, further comprising a diffuser in the second portion.

37. The generator of any one of clauses 26-36, wherein the diffuser comprises a perforated plate including perforations, the perforations have sizes configured to prevent passage of the solid ²²⁹Th peroxide therethrough.

38. The generator of any one of clauses 26-37, wherein the perforations are configured to allow a liquid solvent to pass therethrough.

39. The generator of any one of clauses 26-38, further comprising:

a shield positioned to intercept alpha radiation from the ²²⁹Th contained in the interior chamber.

40. A pharmaceutical composition comprising the ²²⁹Ac generated by any of the above clauses.

41. The pharmaceutical composition of clause 40 further comprising:

a pharmaceutically acceptable carrier.

42. The pharmaceutical composition of clauses 40-41, wherein the ²²⁵Ac is conjugated to an antibody.

43. A method of treating cancer in a patient comprising administering to the patient the pharmaceutical composition of any of clauses 40-42.

44. The method of clause 44, wherein the cancer is breast cancer, a leukemia, a lymphoma, brain cancer, liver cancer, lung cancer, melanoma, ovarian cancer, prostate cancer, pancreatic cancer, or bone cancer.

It will be clear that the systems and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. For example, instead of a cover solution, at times during the process such as between separations, the thorium peroxide may be maintained under a cover gas. Additionally, in some of the Examples above the thorium peroxide is maintained on the fritted disc of a filter funnel throughout the process, thus the filter funnel acts as the actinium generator. Alternatively, any suitable solid liquid separator could be used, such as a fluidized bed reactor, centrifugal separator, a line filter, or hydrocyclone, to name but a few options. Additionally, in an embodiment where one valve is used on a simple generator, a simple separation operation could include tipping the generator to allow the liquid phase to run out through the valve under gravity, returning the generator to a valve up orientation, and then refilling the generator with new solution for storage. Numerous other changes may be made which will readily suggest themselves to those skilled in the art and which are encompassed in the spirit of the disclosure.

What is claimed is:

1. A method for generating ²²⁵Ac and ²²⁵Ra from ²²⁹Th comprising:
providing a first suspension of solid ²²⁹Th peroxide with a cover liquid solution;
storing the first suspension for a first period of time during which at least some ²²⁹Th decays into ²²⁵Ac; and
separating the solid ²²⁹Th peroxide from at least some of the cover liquid solution of the first suspension to obtain a quantity of separated solid ²²⁹Th peroxide and a first liquid solution containing at least some ²²⁵Ac.

2. The method of claim 1 further comprising:
after separating the solid ²²⁹Th peroxide from the cover liquid, adding an amount of fresh cover liquid to the separated solid ²²⁹Th peroxide to create a second suspension.

3. The method of claim 2 further comprising:
storing the second suspension for a second period of time during which at least some ²²⁹Th decays into ²²⁵Ac; and
separating the solid ²²⁹Th peroxide from at least some of the cover liquid solution of the second suspension to obtain a quantity of separated solid ²²⁹Th peroxide and a second liquid solution containing at least some ²²⁵Ac.

4. The method of claim 1 wherein separating the solid ²²⁹Th peroxide from the cover liquid solution further comprises:
agitating the first suspension or the second suspension prior to separating the solid ²²⁹Th peroxide from the cover liquid solution.

5. The method of any of claim 1 wherein separating the solid ²²⁹Th peroxide from the cover liquid solution further comprises:
maintaining an excess amount of peroxide in the cover liquid solution.

6. The method of claim 5, wherein maintaining an excess amount of peroxide in the cover liquid solution comprises:
adding a H₂O₂ solution to the first suspension or the second suspension prior to separating the solid ²²⁹Th peroxide from the cover liquid solution.

7. The method of claim 6, wherein the H₂O₂ solution is from 5% to 50% by weight H₂O₂.

8. The method of claim 6, wherein the H₂O₂ solution is from 25% to 35% by weight H₂O₂.

9. The method of claim 1, wherein providing the first suspension comprises:
dissolving an amount of ²²⁹ThCl₄.ₓH₂O or ²²⁹Th(NO₃)₄.ₓH₂O in an acid solution to obtain a dissolved ²²⁹Th solution; and
adding an amount of H₂O₂ to the dissolved ²²⁹Th solution thereby forming solid ²²⁹Th peroxide and a residue liquid phase;
separating the solid ²²⁹Th peroxide from the residue liquid phase; and
adding the solid ²²⁹Th peroxide to an acidic cover liquid solution to create the first suspension.

10. The method of claim 1, wherein separating the solid ²²⁹Th peroxide from the cover liquid solution includes one or more of filtering, centrifuging, and gravity settling.

11. The method of claim 1, wherein the cover liquid solution is a NaNO₃ liquid solution.

12. The method of claim 11, wherein the cover liquid solution is a NaNO₃ solution of from 0.01 to 10.0 M NaNO₃.

13. The method of claim 1, wherein the cover solution is a HNO₃ solution.

14. The method of claim 13, wherein the cover liquid solution is a HNO₃ solution of from 0.01 to 10.0 M HNO₃.

15. The method of claim 1, wherein the first period of time is 25 days or less.

16. The method of any of claims 1-18, further comprising:
maintaining the first suspension and/or the second suspension at a pH from 0.5 to 3.

17. The method of claim 19 or 20, wherein maintaining the first suspension and the second suspension at a pH from 0.5 to 3 further comprises:
adding a solution of either KOH or HNO₃ as needed to the first suspension or the second suspension.

18. A pharmaceutical composition comprising the ²²⁵Ac generated by the method of claim 1.

19. A system for generating ²²⁵Ac and ²²⁵Ra from ²²⁹Th comprising:
a vessel containing a suspension of solid ²²⁹Th peroxide with a cover liquid.

20. A ²²⁵Ac generator, comprising:
a first portion of the generator;
a column body defining an interior chamber;
a first access port at the first portion of the generator providing access to the interior chamber; and
an amount of solid ²²⁹Th peroxide contained in the interior chamber.
